(19) United States
(12) Patent Application Publication
(10) Pub. No.: US 2026/0229401 A1
(43) Pub. Date: Aug. 6, 2026

(54) COIL COMPONENT, AND ELECTRONIC COMPONENT, SEMICONDUCTOR COMPONENT, AND SUBSTRATE INCLUDING COIL COMPONENT

(71) Applicant: Murata Manufacturing Co., Ltd., Kyoto-fu (JP)

(72) Inventors: Yoshimasa YOSHIOKA, Nagaokakyo-shi (JP); Kenji TOYOSHIMA, Nagaokakyo-shi (JP); Kouji YAMAUCHI, Nagaokakyo-shi (JP)

(73) Assignee: Murata Manufacturing Co., Ltd., Kyoto-fu (JP)

(21) Appl. No.: 19/629,974

(22) Filed: Mar. 26, 2026

Related U.S. Application Data
(63) Continuation of application No. PCT/JP2024/015768, filed on Apr. 22, 2024.

(30) Foreign Application Priority Data
Sep. 28, 2023 (JP) 2023-168486

(51) Int. Cl. H01F 27/32; H01F 27/255

(52) U.S. Cl. CPC H01F 27/324; H01F 27/255

(57) ABSTRACT

A coil component includes an element body including a magnetic layer, and a first coil wiring disposed in the element body. The magnetic layer includes resin, first metal magnetic powder, first iron oxide magnetic powder, and a void portion, and an average particle diameter of the first metal magnetic powder is larger than an average particle diameter of the first iron oxide magnetic powder.

### CROSS-REFERENCE TO RELATED APPLICATIONS

This application claims benefit of priority to International Patent Application No. PCT/JP2024/015768, filed Apr. 22, 2024, and to Japanese Patent Application No. 2023-168486, filed Sep. 28, 2023, the entire contents of each are incorporated herein by reference.

### BACKGROUND

### Technical Field

The present disclosure relates to a coil component, and an electronic component, a semiconductor component, and a substrate including the coil component.

### Background Art

Conventionally, an inductor component including an element body including a magnetic layer and a coil conductor formed inside the element body has been studied. For example, Japanese Patent Application Laid-Open No. 2012-238840 describes that a magnetic layer includes metal magnetic powder, a void, and a resin material.

### SUMMARY

In the inductor component described in the prior art, there has been a problem that, when a filling rate of the metal magnetic powder, which is a magnetic material, is increased, magnetic permeability is increased, but eddy current loss is increased, and Q factor is lowered.

In view of the above, the present disclosure provides a coil component in which Q factor is high and inductance acquisition efficiency is improved.

Accordingly, a coil component according to one aspect of the present disclosure includes an element body including a magnetic layer; and a first coil wiring disposed on the same plane in the element body. The magnetic layer includes resin, first metal magnetic powder, first iron oxide magnetic powder, and a void portion, and an average particle diameter of the first metal magnetic powder is larger than an average particle diameter of the first iron oxide magnetic powder.

When the first metal magnetic powder and the first iron oxide magnetic powder having an average particle diameter smaller than that of the first metal magnetic powder are used as a magnetic material, a space between particles of the first metal magnetic powders can be filled with the first iron oxide magnetic powder. By this, it is possible to increase a filling rate of the magnetic material and improve magnetic permeability while ensuring insulation property in the magnetic layer. Further, an average particle diameter of the first iron oxide magnetic powder is easily made smaller than that of the first metal magnetic powder. When an average particle diameter of the first iron oxide magnetic powder is made small, as described above, a space between particles of the first metal magnetic powder can be filled with the first iron oxide magnetic powder, and a filling rate can be safely increased. Furthermore, a void portion included in the resin can relieve stress generated by heat or the like. As a result, it is possible to obtain a coil component having high Q factor and improved inductance acquisition efficiency.

The average particle diameter is an arithmetic mean value obtained from a scanning electron microscope.

According to one aspect of the present disclosure, it is possible to provide a coil component in which Q factor is high and inductance acquisition efficiency is improved.

### BRIEF EXPLANATION OF DRAWINGS

FIG. 1 is a transparent perspective view of an inductor component of a first embodiment;

FIG. 2 is an exploded plan view of the inductor component of FIG. 1;

FIG. 3A is a partially enlarged view of a section of FIG. 1;

FIG. 3B is an explanatory schematic view of FIG. 3A;

FIG. 4 is an explanatory view for explaining a part of a magnetic layer of a first modification example;

FIG. 5 is a partially enlarged view of the magnetic layer of the first modification example;

FIG. 6A is a sectional view taken along line VI-VI illustrating a manufacturing process of the inductor component;

FIG. 6B is a sectional view taken along line VI-VI illustrating a manufacturing process of the inductor component;

FIG. 6C is a sectional view taken along line VI-VI illustrating a manufacturing process of the inductor component;

FIG. 6D is a sectional view taken along line VI-VI illustrating a manufacturing process of the inductor component;

FIG. 6E is a sectional view taken along line VI-VI illustrating a manufacturing process of the inductor component;

FIG. 6F is a sectional view taken along line VI-VI illustrating a manufacturing process of the inductor component;

FIG. 6G is a sectional view taken along line VI-VI illustrating a manufacturing process of the inductor component;

FIG. 6H is a sectional view taken along line VI-VI illustrating a manufacturing process of the inductor component;

FIG. 6I is a sectional view taken along line VI-VI illustrating a manufacturing process of the inductor component;

FIG. 6J is a sectional view taken along line VI-VI illustrating a manufacturing process of the inductor component;

FIG. 6K is a sectional view taken along line VI-VI illustrating a manufacturing process of the inductor component;

FIG. 6L is a sectional view taken along line VI-VI illustrating a manufacturing process of the inductor component;

FIG. 6M is a sectional view taken along line VI-VI illustrating a manufacturing process of the inductor component;

FIG. 7A is a sectional view taken along line VII-VII illustrating a manufacturing process of the inductor component;

FIG. 7B is a sectional view taken along line VII-VII illustrating a manufacturing process of the inductor component;

FIG. 7C is a sectional view taken along line VII-VII illustrating a manufacturing process of the inductor component;

FIG. 7D is a sectional view taken along line VII-VII illustrating a manufacturing process of the inductor component;

FIG. 7E is a sectional view taken along line VII-VII illustrating a manufacturing process of the inductor component;

FIG. 7F is a sectional view taken along line VII-VII illustrating a manufacturing process of the inductor component;

FIG. 8 is an explanatory view for explaining a part of a magnetic layer included in the inductor component of a third embodiment;

FIG. 9 is a partially enlarged view of the magnetic layer included in the inductor component according to the third embodiment;

FIG. 10A is a YZ sectional view illustrating a manufacturing process of the inductor component;

FIG. 10B is a YZ sectional view illustrating a manufacturing process of the inductor component;

FIG. 10C is a YZ sectional view illustrating a manufacturing process of the inductor component;

FIG. 10D is a YZ sectional view illustrating a manufacturing process of the inductor component;

FIG. 10E is a YZ sectional view illustrating a manufacturing process of the inductor component;

FIG. 10F is a YZ sectional view illustrating a manufacturing process of the inductor component;

FIG. 10G is a YZ sectional view illustrating a manufacturing process of the inductor component;

FIG. 10H is a YZ sectional view illustrating a manufacturing process of the inductor component;

FIG. 10I is a YZ sectional view illustrating a manufacturing process of the inductor component;

FIG. 10J is a YZ sectional view illustrating a manufacturing process of the inductor component;

FIG. 10K is a YZ sectional view illustrating a manufacturing process of the inductor component;

FIG. 10L is a YZ sectional view illustrating a manufacturing process of the inductor component;

FIG. 10M is a YZ sectional view illustrating a manufacturing process of the inductor component;

FIG. 10N is a YZ sectional view illustrating a manufacturing process of the inductor component; and

FIG. 10O is a YZ sectional view illustrating a manufacturing process of the inductor component.

### DETAILED DESCRIPTION

Hereinafter, an inductor component which is one aspect of a coil component of the present disclosure will be described in detail with reference to an illustrated embodiment. Although the inductor component is described in the present disclosure, other coil components, capacitor components, and the like may be used. Further, the drawings include partially schematic drawings, and the drawings do not reflect actual dimensions or ratios in some cases.

### First Embodiment

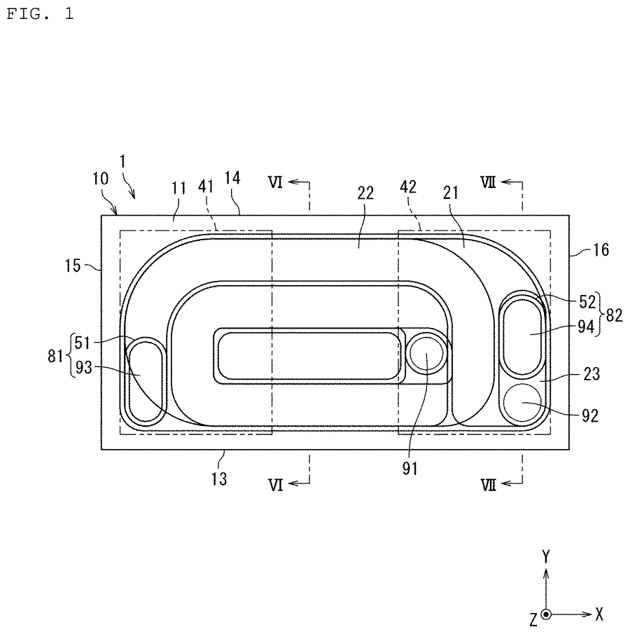

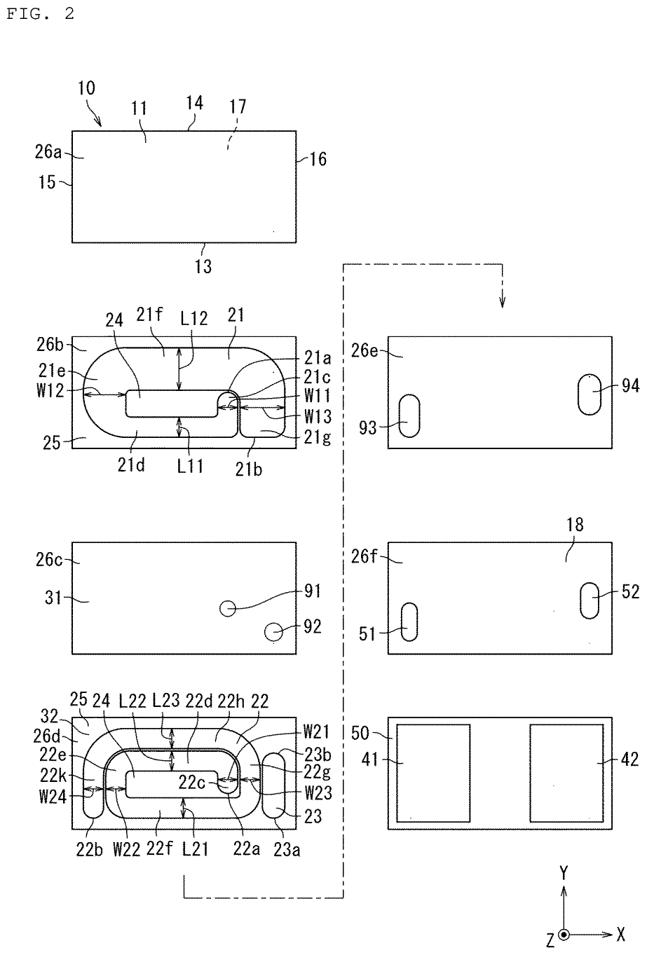

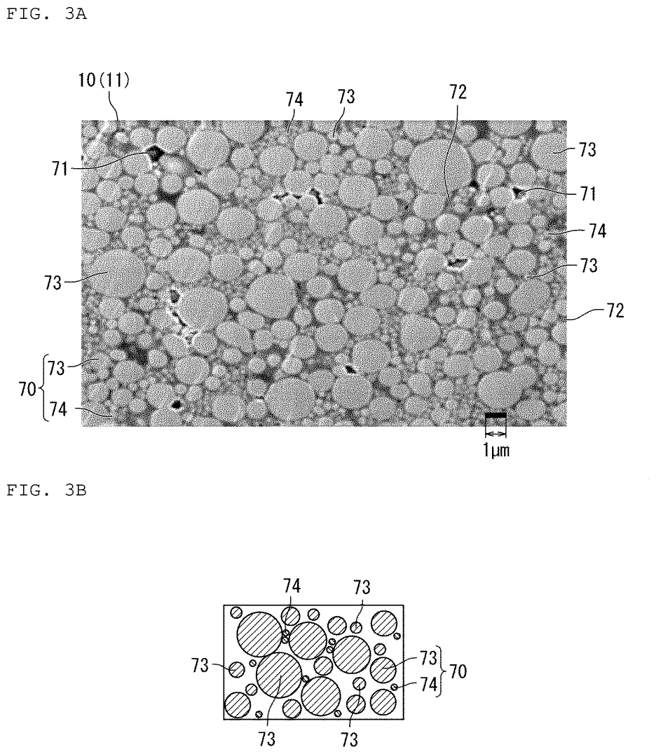

FIG. 1 is a transparent perspective view of an inductor component 1 according to a first embodiment. FIG. 2 is an exploded plan view of the inductor component 1. FIG. 3A is a partially enlarged view of a section of the inductor component 1. FIG. 3B is an explanatory schematic view of FIG. 3A. Note that, in FIG. 1, an external terminal is indicated by a two-dot chain line. In FIGS. 1 and 2, an insulating layer is omitted.

The inductor component 1 is, for example, a surface-mount inductor component mounted on an electronic device such as a personal computer, a DVD player, a digital camera, a TV, a mobile phone, or car electronics. The inductor component 1 may be a semiconductor component. The inductor component 1 may be, for example, a power inductor used for a power supply circuit of an electronic device. Further, a substrate including the inductor component 1 may be used. However, the application of the inductor component 1 is not limited to the above.

The inductor component 1 is a component having a rectangular parallelepiped shape as a whole. Size of the inductor component 1 is, for example, 1.0 mm×0.5 mm×0.5 mm (X dimension×Y dimension×Z dimension). In the present disclosure, the “rectangular parallelepiped shape” includes a shape having irregularities on a part or whole of each surface. Further, in the “rectangular parallelepiped shape” in the present description, each surface and its opposite surface are not necessarily completely parallel, and may have some inclination. That is, adjacent surfaces do not necessarily form a right angle. Note that, the shape of the inductor component 1 is not particularly limited, and may be a columnar shape, a polygonal columnar shape, a truncated cone shape, or a polygonal frustum shape. Further, the size of the inductor component 1 is not particularly limited.

As illustrated in FIGS. 1 to 3A, the inductor component 1 includes an element body 10 including a magnetic layer 11, inductor wirings (coil wirings) 21, 22, and 23 disposed in the element body 10, vertical wirings 81 and 82, external terminals 41 and 42, and a coating film 50. Note that, in FIG. 2, a direction from an upper left layer to a lower right layer (that is, a Z direction) is defined as a lamination direction.

The element body 10 is formed in a substantially rectangular parallelepiped. A surface of the element body 10 includes a first end surface 15 and a second end surface 16 facing each other, a first side surface 13 and a second side surface 14 facing each other, a second main surface (top surface) 17 connected between the first end surface 15 and the second end surface 16 and between the first side surface 13 and the second side surface 14, and a first main surface (bottom surface) 18 facing the second main surface 17. The first main surface 18 is a surface facing a mounting substrate (not illustrated) side when the inductor component 1 is mounted on the mounting substrate.

As illustrated, an X direction is a direction orthogonal to the first end surface 15 and the second end surface 16 and directed from the first end surface 15 toward the second end surface 16. A Y direction is a direction orthogonal to the first side surface 13 and the second side surface 14 and directed from the first side surface 13 to the second side surface 14. The Z direction is a direction orthogonal to the second main surface 17 and the first main surface 18 and directed from the second main surface 17 to the first main surface 18. The X direction is also referred to as a width direction of the element body 10, the Y direction is also referred to as a length direction of the element body 10, and the Z direction is also referred to as a height direction of the element body 10. A positive Z direction is defined as an upward direction, and a negative Z direction is defined as a downward direction. The X direction, the Y direction, and the Z direction are directions orthogonal to each other, and form a right-handed coordinate system when arranged in the order of X, Y, and Z. Size in the X direction may be referred to as a width, size in the Y direction may be referred to as a length, and size in the Z direction may be referred to as a height. The same applies to the X direction, the Y direction, and the Z direction in other embodiments and modification examples.

The first to third inductor wirings 21, 22, and 23 are disposed in the element body 10.

The first inductor wiring 21 contains a conductive material and is wound on a plane. That is, the first inductor wiring 21 is a spiral wiring. Here, the spiral wiring means a wiring having a curved (two-dimensional curve) shape extending on a plane. In the present embodiment, in the first inductor wiring 21, the number of turns drawn by the curve exceeds one turn. Note that the number of turns may be less than one, and a plurality of curves wound in different directions may be included, or a straight line may be included in part. A direction perpendicular to a plane on which the first inductor wiring 21 is wound is the Z direction (vertical direction) in the drawing.

The first inductor wiring 21 has an inner peripheral surface and an outer peripheral surface. The first inductor wiring 21 is formed in a spiral shape in the clockwise direction from an inner peripheral end 21a toward an outer peripheral end 21b when viewed from an upper direction (the direction of the first main surface 18). The inner peripheral end 21a and the outer peripheral end 21b do not need to be strict ends and may slightly extend inward, or may have a protruding portion serving as a current path. The inner peripheral end 21a is formed in a semicircular shape. The outer peripheral end 21b is formed in a substantially rectangular shape. Note that a shape of the inner peripheral end 21a is not limited to a semicircle, and may be a circle including an ellipse, an arc, a polygon, or a combination of these. A shape of the outer peripheral end 21b is not limited to a substantially rectangular shape, and may be a rectangle, a semicircle, a circle including an ellipse, an arc, a polygon, or a combination of these.

Specifically, the first inductor wiring 21 includes a first portion 21c extending in a negative Y direction in parallel with and along the second end surface 16 from the inner peripheral end 21a present on the second end surface 16 side with respect to a center line between the first end surface 15 and the second end surface 16 when viewed from the upper direction, a second portion 21d connected to the first portion 21c and extending in a negative X direction in parallel with and along the first side surface 13, a third portion 21e connected to the second portion 21d and extending in the Y direction in parallel with and along the first end surface 15, a fourth portion 21f connected to the third portion 21e and extending in the X direction in parallel with and along the second side surface 14, and a fifth portion 21g connected to the fourth portion 21f, extending in the negative Y direction in parallel with and along the second end surface 16, and having the outer peripheral end 21b. In the first inductor wiring 21, the second portion 21d is located closest to the first side surface 13. In the first inductor wiring 21, the fourth portion 21f is located closest to the second side surface 14. In the first inductor wiring 21, the third portion 21e is located closest to the first end surface 15. In the first inductor wiring 21, the fifth portion 21g is located closest to the second end surface 16. Note that corner portions between the first portion 21c and the second portion 21d, the second portion 21d and the third portion 21e, the third portion 21e and the fourth portion 21f, and the fourth portion 21f and the fifth portion 21g are curved. Note that the corner portions do not need to be curved.

The first portion 21c has a width dimension (X-direction dimension) W11. The second portion 21d has a length dimension (Y-direction dimension) L11. The third portion 21e has a width dimension W12. The fourth portion 21f has a length dimension L12. The fifth portion 21g has a width dimension W13. Note that the width dimension refers to the maximum dimension in the width direction in the X direction. Further, the length dimension refers to the maximum dimension in the length direction in the Y direction.

In the first inductor wiring 21, the width dimension W11 of the first portion 21c has the same value as the length dimension L11 of the second portion 21d. The width dimension W12 of the third portion 21e, the length dimension L12 of the fourth portion 21f, and the width dimension W13 of the fifth portion 21g have the same value. The length dimension L12 of the fourth portion 21f is twice or more the length dimension L11 of the second portion 21d. Note that “the same value” may be completely the same, but may be slightly different. In the present embodiment, the length dimension L12 is twice or more the length dimension L11 for the convenience of the inductor wiring, but values of the length dimensions L11 and L12 and the width dimensions W11, W12, and W13 are not limited to the above description, and may have different values or the same value. Further, a value of the length dimension and a value of the width dimension are also referred to as wiring widths.

In the first inductor wiring 21, spiral wirings, for example, an outer peripheral surface of the first portion 21c and an inner peripheral surface of the fifth portion 21g are separated from each other. This maintains insulation between the spiral wirings. A distance between the spiral wirings is, for example, 10 μm.

A height dimension in the Z direction of the first inductor wiring 21 is not particularly limited, and is, for example, 10 μm or more and 200 μm or less (i.e., from 10 μm to 200 μm). Note that the height dimension refers to the maximum dimension in the height direction in the Z direction.

As an example of the first inductor wiring 21, the length dimension L11 of the second portion 21d is 90 μm, the length dimension L12 of the fourth portion 21f is 190 μm, and the height dimension of the first inductor wiring 21 is 70 μm.

The second inductor wiring 22 is made from a conductive material and wound on a plane. That is, the second inductor wiring 22 is a spiral wiring. In the present embodiment, in the second inductor wiring 22, the number of turns drawn by the curve exceeds one turn. Note that the number of turns may be less than one, and a plurality of curves wound in different directions may be included, or a straight line may be included in part.

The second inductor wiring 22 has an inner peripheral surface and an outer peripheral surface. The second inductor wiring 22 extends in a normal direction from an inner peripheral end 22a toward an outer peripheral end 22b when viewed from the upper direction, and is spirally wound in the counterclockwise direction. The inner peripheral end 22a and the outer peripheral end 22b do not need to be strict ends and may slightly extend inward, or may have a protruding portion serving as a current path. The inner peripheral end 22a is formed in a semicircular shape. The outer peripheral end 22b is formed in a semicircular shape. Note that shapes of the inner peripheral end 22a and the outer peripheral end 22b are not limited to a semicircular shape, and may be a circle including an ellipse, an arc, a polygon, or a combination of these.

Specifically, the second inductor wiring 22 includes a first portion 22c extending in the Y direction in parallel with and along the second end surface 16 from the inner peripheral end 22a present on the second end surface 16 side with respect to a center line between the first end surface 15 and the second end surface 16 when viewed from the upper direction, a second portion 22d connected to the first portion 22c and extending in the negative X direction in parallel with and along the second side surface 14, a third portion 22e connected to the second portion 22d and extending in the negative Y direction in parallel with and along the first end surface 15, a fourth portion 22f connected to the third portion 22e and extending in the X direction in parallel with and along the first side surface 13, a fifth portion 22g connected to the fourth portion 22f and extending in the Y direction in parallel with and along the second end surface 16, a sixth portion 22h connected to the fifth portion 22g and extending in the negative X direction in parallel with and along the second side surface 14, and a seventh portion 22k connected to the sixth portion 22h, extending in the negative Y direction in parallel with and along the first end surface 15, and having the outer peripheral end 22b. In the second inductor wiring 22, the fourth portion 22f is located closest to the first side surface 13. In the second inductor wiring 22, the sixth portion 22h is located closest to the second side surface 14. In the second inductor wiring 22, the seventh portion 22k is located closest to the first end surface 15. In the second inductor wiring 22, the fifth portion 22g is located closest to the second end surface 16. Note that corner portions between the first portion 22c and the second portion 22d, the second portion 22d and the third portion 22e, the third portion 22e and the fourth portion 22f, the fourth portion 22f and the fifth portion 22g, the fifth portion 22g and the sixth portion 22h, and the sixth portion 22h and the seventh portion 22k are curved. Note that the corner portions do not need to be curved.

The first portion 22c has a width dimension W21. The second portion 22d has a length dimension L22. The third portion 22e has a width dimension W22. The fourth portion 22f has a length dimension L21. The fifth portion 22g has a width dimension W23. The sixth portion 22h has a length dimension L23. The seventh portion 22k has a width dimension W24.

In the second inductor wiring 22, the width dimension W21 of the first portion 22c, the length dimension L22 of the second portion 22d, the width dimension W22 of the third portion 22e, the length dimension L21 of the fourth portion 22f, the width dimension W23 of the fifth portion 22g, the length dimension L23 of the sixth portion 22h, and the width dimension W24 of the seventh portion 22k have the same value. Note that “the same value” may be completely the same, but may be slightly different. Note that the wiring width of the second inductor wiring 22 may have a different value instead of the same value.

The height dimension in the Z direction of the second inductor wiring 22 is not particularly limited, but is, for example, 10 μm or more and 200 μm or less (i.e., from 10 μm to 200 μm).

As an example of the second inductor wiring 22, the width dimension W21 of the first portion 22c, the length dimension L22 of the second portion 22d, the width dimension W22 of the third portion 22e, the length dimension L21 of the fourth portion 22f, the width dimension W23 of the fifth portion 22g, the length dimension L23 of the sixth portion 22h, and the width dimension W24 of the seventh portion 22k are each 90 μm, and the height dimension of the second inductor wiring 22 is 70 μm.

In the second inductor wiring 22, spiral wirings, for example, an outer peripheral surface of the first portion 22c and an inner peripheral surface of the fifth portion 22g, an outer peripheral surface of the second portion 22d and the sixth portion 22h, and the third portion 22e and the seventh portion 22k are separated from each other. This maintains insulation between the spiral wirings. A distance between the spiral wirings is, for example, 10 μm.

The third inductor wiring 23 is made from a conductive material. The third inductor wiring 23 is a linear wiring arranged in parallel with and along the second end surface 16 when viewed from the upper direction. The third inductor wiring 23 has a first end 23a on the first side surface 13 side and a second end 23b on the second side surface 14 side when viewed from the upper direction. The first end 23a is formed in a semicircular shape. The second end 23b is formed in a semicircular shape. Note that shapes of the first end 23a and the second end 23b are not limited to a semicircle, and may be a circle including an ellipse, an arc, a polygon, or a combination of these.

The height dimension in the Z direction of the third inductor wiring 23 is not particularly limited, but is, for example, 10 μm or more and 200 μm or less (i.e., from 10 μm to 200 μm). In the example of the third inductor wiring 23, the height dimension is 70 μm.

The third inductor wiring 23 is flush with the second inductor wiring 22. When viewed from the upper direction, the third inductor wiring 23 is located closer to the second end surface 16 than the second inductor wiring 22. When viewed from the upper direction, the second inductor wiring 22 and the third inductor wiring 23 are separated from each other. By this, the second inductor wiring 22 and the third inductor wiring 23 are insulated. A distance between an outer peripheral surface of the fifth portion 22g of the second inductor wiring 22 and a surface on the second inductor wiring 22 side of the third inductor wiring 23 is, for example, 10 μm.

When viewed from the second end surface 16 direction, the third inductor wiring 23 has a surface that does not overlap the second inductor wiring 22. Specifically, when viewed from the second end surface 16 direction, the second end 23b of the third inductor wiring 23 is located closer to the first side surface 13 than an outer peripheral end on the second side surface 14 side of the second inductor wiring 22. With such a form, volume of a magnetic portion can be increased, and inductance acquisition efficiency can be improved.

When viewed from the second end surface 16 direction, the first inductor wiring 21 is separated from the second inductor wiring 22 and the third inductor wiring 23.

When viewed from the upper direction, the second portion 22d and the sixth portion 22h of the second inductor wiring 22 are located on the fourth portion 21f of the first inductor wiring 21. When viewed from the upper direction, the third portion 22e and the seventh portion 22k of the second inductor wiring 22 are located on the third portion 21e of the first inductor wiring 21. When viewed from the upper direction, the fourth portion 22f of the second inductor wiring 22 is located on the second portion 21d of the first inductor wiring 21. When viewed from the upper direction, the fifth portion 22g of the second inductor wiring 22 and the third inductor wiring 23 are located on the fifth portion 21g of the first inductor wiring 21.

The first inductor wiring 21, the second inductor wiring 22, and the third inductor wiring 23 are made from a conductive material, and for example, made from a low electric resistance metal material such as Cu, Ag, Au, Fe, or an alloy containing these. By this, DC resistance of the first inductor wiring 21, the second inductor wiring 22, and the third inductor wiring 23 can be reduced. Note that the first inductor wiring 21, the second inductor wiring 22, and the third inductor wiring 23 may have different compositions, or may have the same composition.

A via wiring connects inductor wirings. Further, a via wiring connects an inductor wiring and a columnar wiring.

Specifically, a first via wiring 91 extends in the Z direction and connects the inner peripheral end 21a of the first inductor wiring 21 and the inner peripheral end 22a of the second inductor wiring 22. The first via wiring 91 has a circular shape. A second via wiring 92 extends in the Z direction and connects the outer peripheral end 22b of the first inductor wiring 21 and the first end 23a of the third inductor wiring 23. The second via wiring 92 has a circular shape. Note that shapes of the first via wiring 91 and the second via wiring 92 are not particularly limited, and may be other shapes, for example, an elliptical shape.

A third via wiring 93 extends in the Z direction and connects the outer peripheral end 22b of the second inductor wiring 22 and a first columnar wiring 51. The third via wiring 93 has an elliptical shape. A fourth via wiring 94 extends in the Z direction and connects the second end 23b of the third inductor wiring 23 and a second columnar wiring 52. The fourth via wiring 94 has an elliptical shape. Note that shapes of the third via wiring 93 and the fourth via wiring 94 are not particularly limited, and may be other shapes, for example, a circular shape.

When viewed from the upper direction, the second via wiring 92 is located on the first side surface 13 side, and the fourth via wiring 94 is located on the second side surface 14 side. The second via wiring 92 and the fourth via wiring 94 do not overlap when viewed from the upper direction. Note that the second via wiring 92 and the fourth via wiring 94 may at least partially overlap each other when viewed from the upper direction.

The magnetic layer 11 is included in the element body 10. A first main surface of the magnetic layer 11 corresponds to the first main surface 18 of the element body 10, and a second main surface of the magnetic layer 11 corresponds to the second main surface 17 of the element body 10.

The magnetic layer 11 includes resin 72, a magnetic material 70, and a void portion 71. In the present embodiment, the magnetic material 70 includes first metal magnetic powder 73 and first iron oxide magnetic powder 74.

The magnetic layer 11 sandwiches the inductor wirings 21, 22, and 23 from both sides in the Z direction, and is also disposed inside and outside the inductor wirings 21, 22, and 23. As described above, the magnetic layer 11 forms a closed magnetic circuit for the inductor wirings 21, 22, and 23. Note that the magnetic layer 11 may be a laminate of a plurality of magnetic layers, or may be integrated as the magnetic layer 11.

Specifically, the magnetic layer 11 is formed by sequentially laminating a first magnetic portion 26a (also referred to as a lower magnetic layer), a second magnetic portion 26b, a third magnetic portion 26c, a fourth magnetic portion 26d, a fifth magnetic portion 26e, and a sixth magnetic portion 26f (also referred to as an upper magnetic layer). The second magnetic portion 26b includes the first inductor wiring 21, and includes an inner magnetic circuit portion 24 provided inside the first inductor wiring 21 and an outer magnetic circuit portion 25 provided outside the first inductor wiring 21. The third magnetic portion 26c includes the first and second via wirings 91 and 92. The fourth magnetic portion 26d includes the second inductor wiring 22 and the third inductor wiring 23, and includes the inner magnetic circuit portion 24 provided inside the second inductor wiring 22 and the outer magnetic circuit portion 25 provided outside the second and third inductor wirings 22 and 23. The fifth magnetic portion 26e and the sixth magnetic portion 26f include the first and second vertical wirings 81 and 82. The fifth magnetic portion 26e includes the third and fourth via wirings 93 and 94.

A height dimension of the first magnetic portion 26a is preferably larger than a height dimension of each magnetic portion of the second to sixth magnetic portions 26b to 26f. With the above configuration, inductance acquisition efficiency can be improved without increasing processing difficulty. For example, when a height dimension of the magnetic portions 26b to 26f is increased, inductance acquisition efficiency is improved, but difficulty of forming an inductor wiring and a via wiring increases. In the first embodiment, a height dimension of the first magnetic portion 26a is 230 μm, and a height dimension of the sixth magnetic portion 26f is 70 μm. Note that a height dimension of the first magnetic portion 26a may be the same as or smaller than a height dimension of each magnetic portion of the second to sixth magnetic portions 26b to 26f. Further, a height dimension of each magnetic portion of the second to sixth magnetic portions 26b to 26f may be the same as or different from the others.

An insulating layer 31 is embedded in the element body 10 (magnetic layer 11). The insulating layer 31 is in direct contact with the first to third inductor wirings 21 to 23 to coat the first to third inductor wirings 21 to 23. By this, it is possible to enhance insulation between the first inductor wirings 21, between the second inductor wirings 22, and between the second inductor wiring 22 and the third inductor wiring 23. Note that the insulating layer 31 may coat at least a part of the first to third inductor wirings 21 to 23. The insulating layer 31 may be in direct contact with the first to third inductor wirings 21 to 23, or may be disposed apart from the first to third inductor wirings 21 to 23. For example, only a bottom surface (lower surface) of the first to third inductor wirings 21 to 23 may be coated, only a top surface (upper surface) and the bottom surface may be coated, or only a side surface may be coated.

The insulating layer 31 is preferably located at a portion that separates spiral wirings of the first inductor wiring 21 from each other, is located at a portion that separates spiral wirings of the second inductor wiring 22 from each other, and is located at a portion that separates the second inductor wiring 22 and the third inductor wiring 23 from each other.

The insulating layer 31 contains a nonmagnetic insulating material that does not contain a magnetic body. For example, the insulating layer 31 is formed from an insulating resin material including an inorganic filler and an organic resin material.

As a material of the insulating layer 31, for example, resin containing silica (silicon dioxide, typically SiO₂) powder can be used. In this case, strength, workability, and an electrical characteristic of the insulating layer 31 can be improved. Note that the insulating layer 31 does not need to contain silica powder.

Further, resin contained in the insulating layer 31 may contain insulating resin, and preferably contains resin of at least one of epoxy-based resin, acrylic-based resin, phenol-based resin, polyimide-based resin, and liquid crystal polymer-based resin. When the insulating layer 31 contains these insulating resins (organic resins), the first inductor wiring 21, the second inductor wiring 22, and the third inductor wiring 23 are in close contact with the resin 72 contained in the magnetic layer 11 with the resin of the insulating layer 31 interposed between them, and as a result, adhesion strength between the first inductor wiring 21, the second inductor wiring 22, and the third inductor wiring 23 and the magnetic layer 11 can be improved. Further, since insulating organic resin of the insulating layer 31 makes the insulating layer 31 softer than an inorganic material, flexibility can be imparted to the inductor component 1, and mechanical strength and resistance to thermal shock can be improved.

Thickness of the insulating layer 31 is not particularly limited, but may be, for example, 1 μm or more and 20 μm or less (i.e., from 1 μm to 20 μm). In the first embodiment, the insulating layer 31 is in contact with the first to third inductor wirings 21 to 23 to form a layer having a thickness of 10 μm. Note that the thickness of the insulating layer 31 refers to the maximum value of thickness in a direction perpendicular to a surface of an inductor wiring.

An insulating layer 32 included in the insulating layer 31 is embedded in the element body 10. The insulating layer 32 is located at the fourth magnetic portion 26d. The insulating layer 32 is located on a surface that does not overlap between the third inductor wiring 23 and the second inductor wiring 22 when viewed from the second end surface 16.

The first vertical wiring 81 extends in the Z direction so as to expose the fifth magnetic portion 26e and the sixth magnetic portion 26f to the first main surface 18 of the element body 10 from the outer peripheral end 22b side of the second inductor wiring 22. Specifically, the first vertical wiring 81 extends in the upward direction of the outer peripheral end 22b of the second inductor wiring 22 and includes the third via wiring 93 penetrating the fifth magnetic portion 26e, and the first columnar wiring 51 extending on the opposite side from the second inductor wiring 22 of the third via wiring 93 and penetrating the sixth magnetic portion 26f.

The second vertical wiring 82 extends in the Z direction so as to expose the fifth magnetic portion 26e and the sixth magnetic portion 26f on the first main surface 18 of the element body 10 from the second end 23b side of the third inductor wiring 23. Specifically, the second vertical wiring 82 extends in the upward direction of the second end 23b of the third inductor wiring 23 and includes the fourth via wiring 94 penetrating the fifth magnetic portion 26e, and the second columnar wiring 52 extending on the opposite side from the third inductor wiring 23 of the fourth via wiring 94 and penetrating the sixth magnetic portion 26f.

The first vertical wiring 81 and the second vertical wiring 82 contain a conductive material, and contain, for example, low resistance metal such as copper, silver, or gold. Preferably, a conductor containing copper or a copper compound is used as the first vertical wiring 81 and the second vertical wiring 82. By using the material as described above, manufacturing cost for the first and second vertical wirings 81 and 82 can be reduced, and DC resistance in the first and second vertical wirings 81 and 82 can be reduced. The first and second vertical wirings 81 and 82 may be made from copper plating formed by electroless plating (Semi Additive Process, SAP). When SAP is used, the first and second vertical wirings 81 and 82 having low resistance can be obtained at low cost. Note that the first and second vertical wirings 81 and 82 may be formed by a plating method other than SAP, a sputtering method, a vapor deposition method, a coating method, or the like.

The first and second external terminals 41 and 42 are electrically connected to the first to third inductor wirings 21 to 23, and are provided on the first main surface 18 of the element body 10. Specifically, the first external terminal 41 is provided on the first main surface 18, and is disposed on a surface of the first vertical wiring 81 exposed from the first main surface 18. The second external terminal 42 is provided on the first main surface 18, and is disposed on a surface of the second vertical wiring 82 exposed from the first main surface 18. Note that, in the present embodiment, the first and second external terminals 41 and 42 are provided only on the first main surface 18, but may be provided on the first end surface 15 and the first main surface 18 adjacent to the first end surface 15, and on the second end surface 16 and the first main surface 18 adjacent to the second end surface 16. Further, the first external terminal 41 may be provided on the first end surface 15 of the element body 10 and a part of the first side surface 13, the second side surface 14, the second main surface 17, and the first main surface 18 adjacent to the first end surface 15, and the second external terminal 42 may be provided on the second end surface 16 and a part of the first side surface 13, the second side surface 14, the second main surface 17, and the first main surface 18 adjacent to the second end surface 16.

When viewed from the upper direction, the first external terminal 41 covers an exposed surface of the first vertical wiring 81. The second external terminal 42 covers an exposed surface of the second vertical wiring 82. Areas of the first and second external terminals 41 and 42 are larger than areas of the first and second vertical wirings 81 and 82. Note that when viewed from the first main surface 18, areas of the first and second external terminals 41 and 42 may be equal to or less than areas of the first and second vertical wirings 81 and 82.

The first and second external terminals 41 and 42 are formed from, for example, low resistance metal such as copper, silver, or gold. As the first and second external terminals 41 and 42, conductors made from copper or a copper compound may be used. With the above configuration, manufacturing cost for the first and second external terminals 41 and 42 can be reduced, and DC resistance in the first and second external terminals 41 and 42 can be reduced. Preferably, the first and second external terminals 41 and 42 are a laminate in which copper, nickel, and gold are laminated in this order. As examples of the first and second external terminals 41 and 42, copper, nickel, and gold are laminated in this order to thicknesses of 5 μm, 5 μm, and 0.1 μm. Note that the first and second external terminals 41 and 42 may have different compositions.

Materials of the first to third inductor wirings 21 to 23, the first and second vertical wirings 81 and 82, and the first and second external terminals 41 and 42 may be conductors mainly made from copper. With this configuration, it is possible to improve bonding force and conductivity between the first to third inductor wirings 21 to 23, the first and second vertical wirings 81 and 82, and the first and second external terminals 41 and 42. Preferably, the first and second external terminals 41 and 42 are made from copper plating formed by SAP. By using an SAP method, the first and second external terminals 41 and 42 having low resistance can be obtained at low cost. Note that the first and second external terminals 41 and 42 may be formed by a plating method other than SAP, a sputtering method, a vapor deposition method, a coating method, or the like.

The first and second external terminals 41 and 42 may be subjected to rust prevention treatment. The rust prevention treatment is to form a film with nickel (Ni), gold, tin (Sn), or the like. By performing the rust prevention treatment, copper dissolution due to soldering and rust can be suppressed, and reliability in mounting the inductor component 1 can be enhanced.

The coating film 50 is provided on a surface of the magnetic layer 11. The coating film 50 covers a part of the first main surface 18 and exposes end surfaces of the first and second external terminals 41 and 42. By this, insulation property between the external terminals 41 and 42 can be enhanced. Further, the coating film 50 can hide a scratch on the first main surface 18 of the element body 10. Note that the coating film 50 does not need to be provided. Further, the coating film 50 may be provided on a surface other than the first main surface 18. Further, a part of the first and second external terminals 41 and 42 may cover a part of an exposed surface of the coating film 50.

Thickness of the coating film 50 is not particularly limited, but is 1 μm or more and 20 μm or less (i.e., from 1 μm to 20 μm). For example, thickness of the coating film 50 is 10 μm.

The coating film 50 is made from a nonmagnetic insulating material that does not contain a magnetic body. The coating film 50 is formed from, for example, photosensitive resist, solder resist, or dry film resist made from organic insulating resin such as epoxy-based resin, phenol-based resin, and polyimide-based resin. Note that the coating film 50 may be made from the same material as or a different material from the insulating layer 31.

Hereinafter, the magnetic layer 11 will be described in detail.

As illustrated in FIG. 3A, the magnetic layer 11 includes the resin 72, the first metal magnetic powder 73, the first iron oxide magnetic powder 74, and the void portion 71, and an average particle diameter of the first metal magnetic powder 73 is larger than an average particle diameter of the first iron oxide magnetic powder 74. Note that FIG. 3B is a schematic diagram illustrating the first metal magnetic powder 73 and the first iron oxide magnetic powder 74 in FIG. 3A. In FIG. 3B, the void portion 71 and the resin 72 are omitted.

Conventionally, it has been attempted to increase a filling rate in a magnetic layer by using only the first metal magnetic powder as a magnetic material. However, when a filling rate of the first metal magnetic powder is increased, particles of the first metal magnetic powder come into contact with each other, and loss tan δ of a magnetic material may increase due to eddy current loss, and it is difficult to increase the filling rate of the first metal magnetic powder.

On the other hand, in the present embodiment, the first metal magnetic powder 73 and the first iron oxide magnetic powder 74 are used as the magnetic material 70. Since an average particle diameter of the first iron oxide magnetic powder 74 is smaller than an average particle diameter of the first metal magnetic powder 73, the first iron oxide magnetic powder 74 can be disposed between particles of the first metal magnetic powder 73. In the present embodiment, by using the first metal magnetic powder 73 and the first iron oxide magnetic powder 74, it is possible to increase a filling rate of the magnetic material 70 while ensuring insulation property, and it is possible to improve magnetic permeability. Furthermore, stress generated by heat or the like can be relieved by the void portion 71. As described above, the inductor component 1 having excellent inductance acquisition efficiency can be obtained. Note that the “filling rate of the magnetic material 70” refers to a ratio of an area of the magnetic material 70 to an area of the magnetic layer 11 in any section orthogonal to the first side surface 13 and the second side surface 14 of the magnetic layer 11 and the second main surface 17 and the first main surface 18.

In the inductor component 1 and the magnetic layer 11, an average particle diameter is an arithmetic mean value obtained from a Scanning Electron Microscope (hereinafter sometimes referred to as “SEM”) in a section orthogonal to the first main surface 18 and the second main surface. Specifically, in an SEM image at a magnification enabling observation of 15 or more particles of the first metal magnetic powder 73, areas of particles of the first metal magnetic powder 73 are measured, an equivalent circle diameter is calculated by {4/π×(area)}\hat{ }(½), and then an arithmetic mean value of them is obtained as an average particle diameter of the first metal magnetic powder 73. In a case where a contour of the first metal magnetic powder 73 is unclear in the SEM image, image processing is preferably used. Note that, in a raw material state of the first metal magnetic powder 73, the average particle diameter is median diameter D50, and refers to a particle diameter corresponding to an integrated value of 50% in particle size distribution obtained by a laser diffraction and scattering method.

As the first metal magnetic powder 73, for example, magnetic metal containing iron (Fe) can be used. The first metal magnetic powder 73 may contain iron alone or may be an alloy containing iron. For example, the first metal magnetic powder 73 is an iron-copper (Cu)-based alloy, an iron-silicon-based alloy such as an iron-silicon (Si)-chromium (Cr) alloy, an iron-cobalt (Co)-based alloy, an iron-based alloy such as permalloy (NiFe), or an amorphous alloy of these. The first metal magnetic powder 73 is preferably carbonyl iron (carbonyl Fe, Fe(CO)₅).

Preferably, the first metal magnetic powder 73 contains Fe and does not contain O. Here, “not containing O” means that an element ratio of oxygen is 5% by mass or less, preferably 0% by mass in the first metal magnetic powder 73.

The first metal magnetic powder 73 does not necessarily have a spherical shape, but preferably has a spherical shape. Note that in the present specification, the “spherical shape” includes a partially missing spherical shape and a distorted spherical shape in addition to a spherical shape having a constant diameter. An average particle diameter of the first metal magnetic powder 73 is, for example, 0.5 μm or more and 2.5 μm or less (i.e., from 0.5 μm to 2.5 μm). Here, the average particle diameter is a value measured using an SEM.

The first metal magnetic powder 73 may have an insulating coating portion on its surface. That is, the first metal magnetic powder 73 may have a metal magnetic powder portion and an insulating coating portion provided on a surface of the metal magnetic powder portion.

The first iron oxide magnetic powder 74 contains, for example, iron (II) oxide (FeO) and iron (III) oxide (Fe₃O₄).

The first iron oxide magnetic powder 74 may further contain other atoms. Examples of the other atoms include Cu, Al, Zr, and C. The first iron oxide magnetic powder 74 containing the other atoms is obtained, for example, by adding the other atoms to a slurry of iron oxide. By adding the other atoms, lattice defects in the first iron oxide magnetic powder 74 can be reduced, and crystallinity can be controlled. For example, the first iron oxide magnetic powder 74 may contain Fe in an amount of 50% by mass or more and 69% by mass or less (i.e., from 50% by mass to 69% by mass), and may contain O in an amount of 19.5% by mass or more and 24.7% by mass or less (i.e., from 19.5% by mass to 24.7% by mass). Further, the first iron oxide magnetic powder 74 may contain C in an amount of 19.5% by mass or more and 24.7% by mass or less (i.e., from 19.5% by mass to 24.7% by mass), Cu in an amount of 2.2% by mass or more and 2.5% by mass or less (i.e., from 2.2% by mass to 2.5% by mass), Zr in an amount of 1.5% by mass or more and 1.7% by mass or less (i.e., from 1.5% by mass to 1.7% by mass), and Al in an amount of 1.2% by mass or less.

In the present disclosure, an average particle diameter of the first iron oxide magnetic powder 74 is measured using the same method as that for the first metal magnetic powder 73.

The first iron oxide magnetic powder 74 does not necessarily have a spherical shape, but preferably has a spherical shape. An average particle diameter of the first iron oxide magnetic powder 74 is, for example, 0.01 μm or more and 0.5 μm or less (i.e., from 0.01 μm to 0.5 μm).

The resin 72 preferably contains at least one of epoxy-based resin and acrylic-based resin. By this, insulating property of the magnetic layer 11 can be improved. Further, mechanical strength of the magnetic layer 11 can be improved by a stress relieving effect by the resin 72.

The void portion 71 is included in the resin 72 and the magnetic material 70. The void portion 71 may be in contact with only the resin 72 or may be in contact with the resin 72 and the magnetic material 70. The void portion 71 can be formed, for example, by sintering a composition containing the resin 72 and the magnetic material 70. Hereinafter, a composition containing the resin 72 and the magnetic material 70 may be referred to as a composition C.

Preferably, at least one particle of the first metal magnetic powder 73 and at least one particle of the first iron oxide magnetic powder 74 are in contact with each other. With the above configuration, a filling rate of the magnetic material 70 is increased. Here, “in contact” means that at least one particle of the first metal magnetic powder 73 and at least one particle of the first iron oxide magnetic powder 74 are in contact with each other in any section orthogonal to the first side surface 13 and the second side surface 14 and the first main surface 18 and the second main surface 17. Note that in a case where the first metal magnetic powder 73 has an insulating coating portion, contact between the first metal magnetic powder 73 and the first iron oxide magnetic powder 74 means contact between the insulating coating portion and the first iron oxide magnetic powder 74.

Contact between the first metal magnetic powder 73 and the first iron oxide magnetic powder 74 can be checked by an image acquired using an SEM. In order to acquire an SEM image, first, preparation of a section of a central portion of the inductor component 1 is performed. After that, an image of a portion of the magnetic layer 11 in the sectional portion of the inductor component 1 is acquired by an SEM. Then, three or more images of different locations in the vertical direction (Z direction) are acquired at an appropriate magnification in a portion of the magnetic layer 11 in the sectional portion of the inductor component 1, and contact between the first metal magnetic powder 73 and the first iron oxide magnetic powder 74 is confirmed by checking the acquired SEM image. Note that a magnification of an SEM is preferably appropriately changed according to size of the first metal magnetic powder 73, but the magnification at which 15 or more particles of the first metal magnetic powder 73 can be checked is preferable, and for example, the magnification can be in a range of 500 times to 5,000 times, and preferably 5,000 times. The central portion of the inductor component 1 is a portion orthogonal to the first main surface 18, the second main surface 17, the first side surface 13, and the second side surface 14, and including a part of the inner magnetic circuit portion 24 of the first and second inductor wirings 21 and 22.

Preferably, at least one particle of the first metal magnetic powder 73 is in contact with at least one particle of the first iron oxide magnetic powder 74 and the at least one void portion 71. Even in a case where the first metal magnetic powder 73 expands due to stress such as heat and generates stress, the stress can be relieved in the void portion 71 by the first metal magnetic powder 73 and the void portion 71 coming into contact with each other. Further, since a linear expansion coefficient of the first iron oxide magnetic powder 74 is different from a linear expansion coefficient of the first metal magnetic powder 73, a linear expansion coefficient difference occurs between the first iron oxide magnetic powder 74 and the first metal magnetic powder 73, but the void portion 71 and the first metal magnetic powder 73 come into contact with each other and the void portion 71 can absorb the linear expansion coefficient difference, so that stress can be relieved in a more excellent manner. Furthermore, since resistance of the first iron oxide magnetic powder 74 is higher than resistance of the first metal magnetic powder 73, as the first iron oxide magnetic powder 74 and the first metal magnetic powder 73 come into contact with each other, insulation between particles of the first metal magnetic powder 73 is secured by the first iron oxide magnetic powder 74, and iron loss can be suppressed.

### Modification Example

FIG. 4 is an explanatory view of a first modification example of the inductor component 1 according to the first embodiment. FIG. 5 is a partially enlarged view of the first modification example of the inductor component 1 according to the first embodiment. As illustrated in FIG. 4, in the present modification example, the inductor component includes the element body 10 (magnetic layer 11), the first inductor wiring 21 disposed in the element body 10, and the insulating layer 31 in contact with a surface on the second main surface 17 side of the first inductor wiring 21. As illustrated in FIG. 5, in the present modification example, the inductor component includes the element body 10 (magnetic layer 11) and the first vertical wiring 81. Note that in the explanatory view, the description is simplified, and actual dimensions and ratios are not reflected in some cases.

As illustrated in FIGS. 4 and 5, in the magnetic layer 11, at least one particle of the first metal magnetic powder 73 is in contact with the first inductor wiring 21, the at least one void portion 71, and at least one particle of the first iron oxide magnetic powder 74. With the above configuration, a filling rate can be further increased, and the inductor component 1 having excellent inductance efficiency can be obtained. Note that, as illustrated in FIG. 5, in the magnetic layer 11, at least one particle of the first metal magnetic powder 73 may be in contact with the first vertical wiring 81, the at least one void portion 71, and at least one particle of the first iron oxide magnetic powder 74. Note that in the present modification example, the first inductor wiring 21 and the first vertical wiring 81 are raised, but the second inductor wiring 22, the third inductor wiring 23, or the second vertical wiring 82 may be used.

In the modification example, preferably, at least one particle of the first metal magnetic powder 73 is in contact with the first inductor wiring 21, the at least one void portion 71, and at least one particle of the first iron oxide magnetic powder 74. With the above configuration, a filling rate can be further increased, and the inductor component 1 having excellent inductance efficiency can be obtained. In the present embodiment, since the first inductor wiring 21 may also be in contact with the magnetic layer 11, inductance efficiency of the inductor component 1 is also improved.

Preferably, the first metal magnetic powder 73 contains Fe in an amount of 95% by mass or more. By containing a large amount of Fe, DC bias characteristics can be improved. An upper limit value of content of Fe contained in the first metal magnetic powder 73 is not particularly limited, but is, for example, 99% by mass or less. In the present disclosure, content of an element contained in the first metal magnetic powder 73 is a value obtained by measuring a central portion of the first metal magnetic powder 73 by using energy dispersive X-ray spectroscopy (also referred to as “EDX”). The content of an element can be obtained, for example, by measuring content of the element at four points and determining an average value of the content. Note that the center includes not only an exact central portion but also a substantially central portion.

Preferably, the first metal magnetic powder 73 contains Cu in an amount of 1% by mass or more and 5% by mass or less (i.e., from 1% by mass to 5% by mass). By containing Cu in the above amount, influence of a demagnetizing field in the first metal magnetic powder 73 can be reduced. Further, by containing Cu in the above amount, hardness of the first metal magnetic powder 73 can be reduced as compared with a case where only Fe is contained.

Preferably, the first iron oxide magnetic powder 74 contains Fe in an amount of 50% by mass or more. An upper limit value of content of Fe contained in the first iron oxide magnetic powder 74 is not particularly limited, but is, for example, 85% by mass or less, and may be, for example, 70% by mass or less. In the first iron oxide magnetic powder 74, by setting content of Fe to be equal to or less than a predetermined value, electrical conductivity is lowered, and eddy current between particles of magnetic powder is reduced, so that iron loss can be suppressed. By setting content of Fe to a predetermined value or more, DC bias characteristics are improved.

The first iron oxide magnetic powder 74 may contain carbon (C), oxygen (O), copper (Cu), zirconium (Zr), aluminum (Al), and the like together with Fe. For example, C may be contained in an amount of 19% by mass or more and 25% by mass or less (i.e., from 19% by mass to 25% by mass). O may be contained in an amount of 5% by mass or more and 17% by mass or less (i.e., from 5% by mass to 17% by mass). Cu may be contained in an amount of 2.2% by mass or more and 2.5% by mass or less (i.e., from 2.2% by mass to 2.5% by mass). Zr may be contained in an amount of 1.5% by mass or more and 1.7% by mass or less (i.e., from 1.5% by mass to 1.7% by mass). Al may be contained in an amount of 1.2% by mass or less. Content of an element contained in the first iron oxide magnetic powder 74 is a value obtained by measuring the center of the first iron oxide magnetic powder 74 by using EDX, similarly to the first metal magnetic powder 73. Note that the first iron oxide magnetic powder 74 does not need to contain C, O, Cu, Zr, and Al.

Preferably, an average particle diameter of the first metal magnetic powder 73 is 0.5 μm or more and 2.5 μm or less (i.e., from 0.5 μm to 2.5 μm), an average particle diameter of the first iron oxide magnetic powder 74 is 0.01 μm or more and 0.5 μm or less (i.e., from 0.01 μm to 0.5 μm), and an average particle diameter of the first metal magnetic powder 73 is 5 times or more the average particle diameter of the first iron oxide magnetic powder 74. By pulverizing the magnetic material 70, particularly the first iron oxide magnetic powder 74, iron loss can be suppressed, and the inductor component 1 can also be used in a power inductor that performs high-speed switching operation at high frequencies, specifically, 50 MHz to 100 MHz. Further, since an average particle diameter of the first iron oxide magnetic powder 74 is smaller than an average particle diameter of the first metal magnetic powder 73, a particle of the first metal magnetic powder 73 moves on a particle of the first iron oxide magnetic powder 74 due to ball bearing effect, by which a filling rate of the magnetic material 70 is improved.

Preferably, in the magnetic layer 11, a filling rate of the first metal magnetic powder 73 is higher than a filling rate of the first iron oxide magnetic powder 74. With the above configuration, it is possible to provide the inductor component 1 having high DC bias characteristics. Note that the “filling rate of the first metal magnetic powder 73” refers to an area ratio of the first metal magnetic powder 73 in any section orthogonal to the first side surface 13 and the second side surface 14 of the magnetic layer 11 and the first main surface 18 and the second main surface 17. The “filling rate of the first iron oxide magnetic powder 74” refers to an area ratio of the first iron oxide magnetic powder 74 in any section orthogonal to the first side surface 13 and the second side surface 14 of the magnetic layer 11 and the first main surface 18 and the second main surface 17.

Preferably, the first metal magnetic powder 73 includes an insulating coating portion, and the at least one insulating coating portion and at least one particle of the first iron oxide magnetic powder 74 are in contact with each other. Since the first metal magnetic powder 73 includes insulating coating, contact between metals can be reduced, and iron loss in the magnetic layer 11 can be reduced.

For example, the first iron oxide magnetic powder 74 may contain iron (Fe) and oxygen (O), Fe may be contained in an amount of 60% by mass or more and 85% by mass or less (i.e., from 60% by mass to 85% by mass), content of O may be high following content of Fe, and electrical conductivity of the first metal magnetic powder 73 may be 10 times or more higher than electrical conductivity of the first iron oxide magnetic powder 74. In the first iron oxide magnetic powder 74, if content of Fe is too high, electrical conductivity increases, and eddy current between particles of magnetic powder increases, so that iron loss increases. When content of Fe is too low, DC bias characteristics are lowered. On the other hand, iron loss can be suppressed by setting content of Fe within the above range and setting content of O to be high following content of Fe. Note that electrical conductivity of the first metal magnetic powder 73 may be 10⁷ times or less electrical conductivity of the first iron oxide magnetic powder 74. Note that the first iron oxide magnetic powder 74 may contain atoms other than O following Fe.

Preferably, a linear expansion coefficient of the first metal magnetic powder 73 is larger than a linear expansion coefficient of the first iron oxide magnetic powder 74. When stress of the first metal magnetic powder 73 is large, strain is generated, therefore internal stress of the inductor component 1 can be relieved by adding the first iron oxide magnetic powder 74 having a small linear expansion coefficient.

Preferably, circularity of the first metal magnetic powder 73 and the first iron oxide magnetic powder 74 is higher than 0.9. With the above configuration, particles of the magnetic powder slide due to ball bearing effect, and a filling rate can be further improved. The circularity is obtained by 4π×(area)/(perimeter)². An area and a peripheral length are measured using image processing software, for example, WinROOF2018 (manufactured by MITANI CORPORATION). Specifically, in any section, circularities are obtained from 10 or more aggregate portions, and an average value of them is taken as the circularity.

The magnetic layer 11 may further contain second metal magnetic powder. With the above configuration, characteristics of the inductor component 1 can be adjusted. By changing a mixing ratio of the first metal magnetic powder 73 and the second metal magnetic powder, the balance between effective magnetic permeability and DC bias characteristics can be changed.

Preferably, the first metal magnetic powder 73 is carbonyl iron-based magnetic powder, the second metal magnetic powder is amorphous alloy-based magnetic powder, and an average particle diameter of the second metal magnetic powder is larger than an average particle diameter of the first metal magnetic powder 73. For example, by containing a material that is easily oxidized such as chromium (Cr), resistance of amorphous alloy-based resin powder that is the second metal magnetic powder can be increased. As a result, even when an average particle diameter of the amorphous alloy-based resin powder is large, eddy current loss can be suppressed, and magnetic permeability can be increased. Furthermore, by using carbonyl iron-based resin powder as the first metal magnetic powder 73 together with the amorphous alloy-based resin powder, a filling rate can be improved, and magnetic permeability can be increased. By using the first iron oxide magnetic powder 74 together with the first metal magnetic powder 73 and the second metal magnetic powder, a particle of the first metal magnetic powder 73 and a second metal magnetic powder particle move on a particle of the first iron oxide magnetic powder 74 due to ball bearing effect, by which a filling rate can be further increased.

### EXAMPLE

An SEM image of the inductor component 1 is illustrated in FIG. 3A. A measurement apparatus is energy dispersive X-ray spectroscopy (SEM-EDX) (manufactured by BEL Microtrac Corp., MT3300-EX), and the magnification is 5,000 times. In Example, epoxy resin was used as the resin 72, carbonyl iron was used as the first metal magnetic powder 73, and magnetite (Fe₃O₄) was used as the first iron oxide magnetic powder 74. As illustrated in FIG. 3A, it was found that the magnetic layer 11 included the resin 72, the first metal magnetic powder 73, the first iron oxide magnetic powder 74, and the void portion 71, and the first metal magnetic powder 73, the first iron oxide magnetic powder 74, and the void portion 71 were in contact with each other. Note that FIG. 3B is a schematic view illustrating the first metal magnetic powder 73 and the first iron oxide magnetic powder 74 in FIG. 3A.

Table 1 shows an elemental analysis result of the first metal magnetic powder 73, and Table 2 shows an elemental analysis result of the first iron oxide magnetic powder 74. From Table 1, it was found that the first metal magnetic powder 73 contained 95% by mass or more of Fe and 1% by mass or more and 5% by mass or less (i.e., from 1% by mass to 5% by mass) of Cu. Note that the elemental analysis in Tables 1 and 2 shows a value measured using SEM-EDX.

TABLE 1

| | Spectrum | Spectrum | Spectrum | Spectrum | Aver- |
|---|---|---|---|---|---|
| | 1 (% | 2 (% | 3 (% | 4 (% | age (% |
| Element | by mass) | by mass) | by mass) | by mass) | by mass) |
| Fe | 95.9 | 95.9 | 96.1 | 96.6 | 96.1 |
| Cu | 4.1 | 4.1 | 3.9 | 3.4 | 3.9 |

TABLE 2

| | Spectrum | Spectrum | Spectrum | Spectrum | Aver- |
|---|---|---|---|---|---|
| | 11 (% | 12 (% | 13 (% | 14 (% | age (% |
| Element | by mass) | by mass) | by mass) | by mass) | by mass) |
| Fe | 63.9 | 68.4 | 57.0 | 53.5 | 60.7 |
| C | 19.5 | 22.2 | 23.9 | 24.7 | 22.6 |
| O | 12.5 | 5.3 | 14.1 | 16.3 | 12.1 |
| Cu | 2.2 | 2.5 | 2.2 | 2.2 | 2.3 |
| Zr | 1.6 | 1.5 | 1.6 | 1.7 | 1.6 |
| Al | 0.3 | | 0.7 | 1.2 | 0.7 |

Note that, in Table 2, only a main element is described. Therefore, there is a spectrum in which a total amount is not 100%. Further, since a particle diameter of the first iron oxide magnetic powder 74 is smaller than the resolution of SEM-EDX, C and O were higher than an original composition in some cases due to influence of the resin 72 around the first iron oxide magnetic powder 74 in Table 2. For this reason, it is preferable to measure a more accurate elemental analysis value of the first iron oxide magnetic powder 74 by using SEM-EDX for the first iron oxide magnetic powder 74 before mixing.

With the above configuration, Q factor was 20 or more at 100 MHz and was excellent.

### (Manufacturing Method)

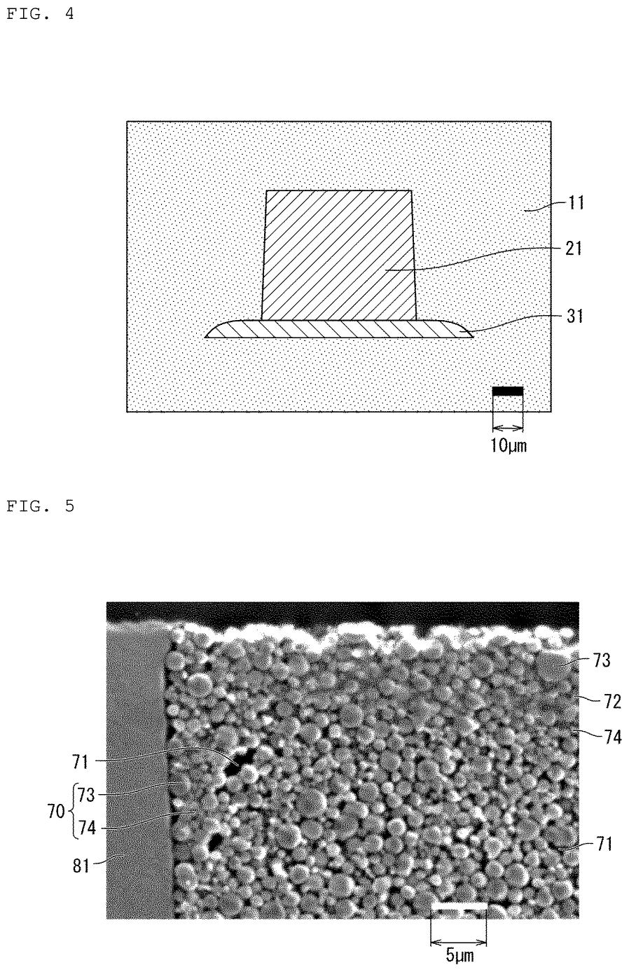

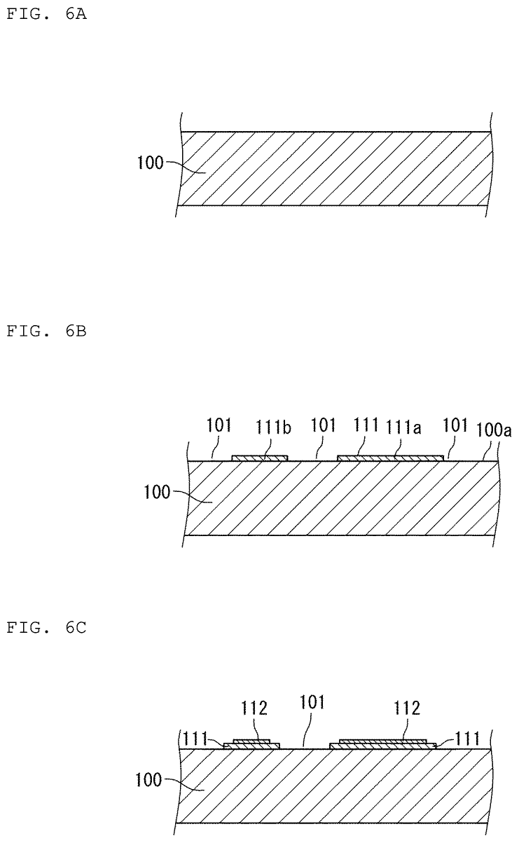

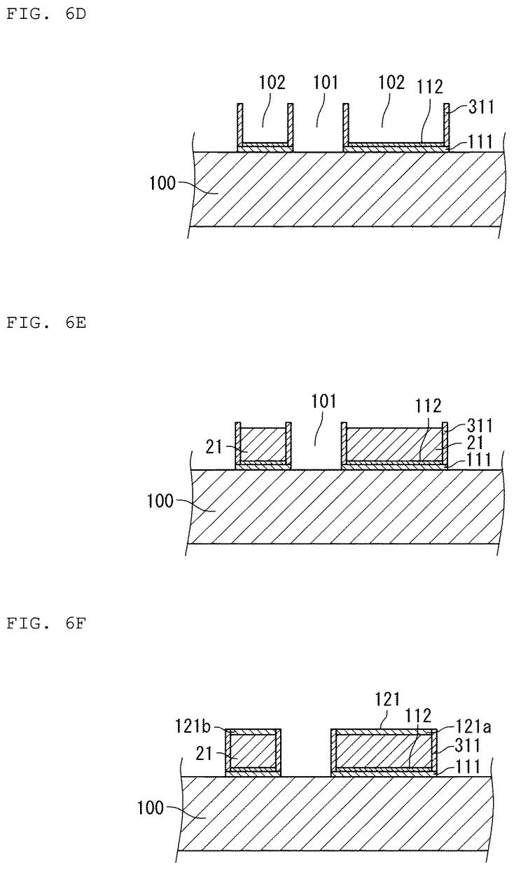

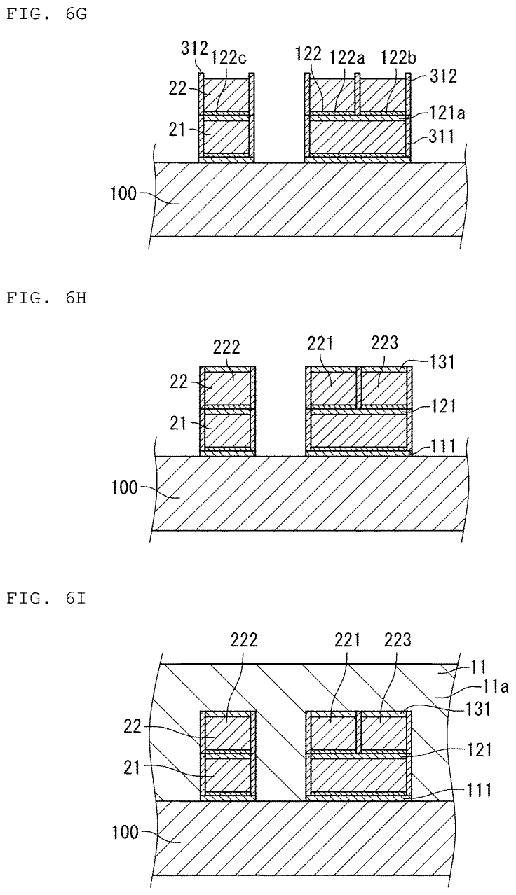

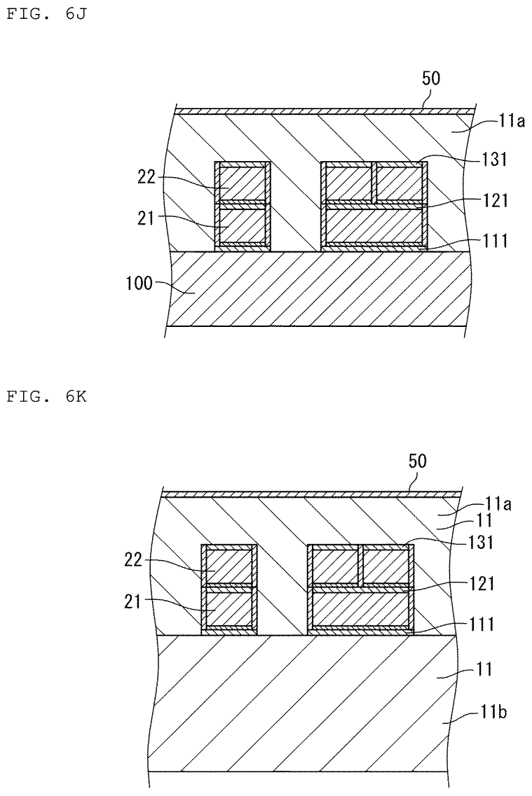

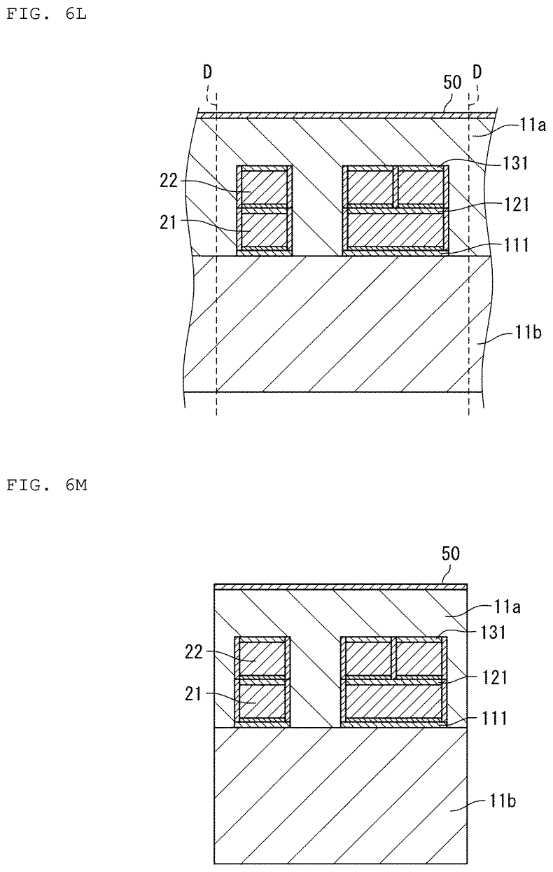

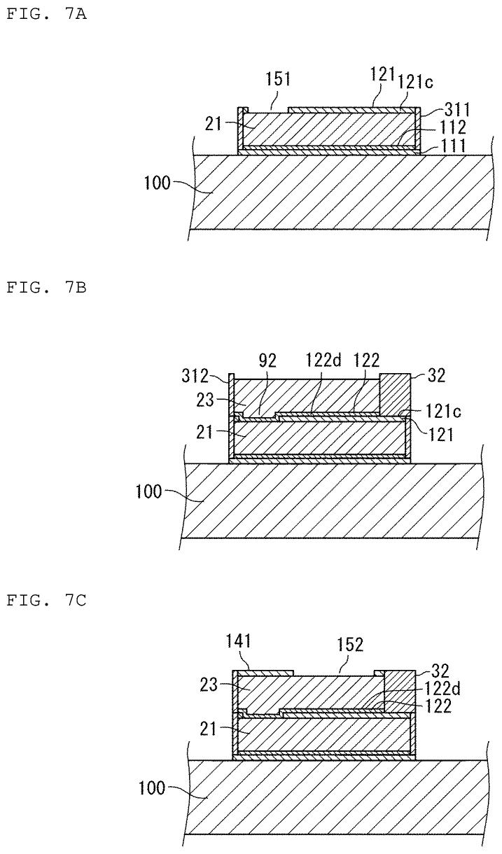

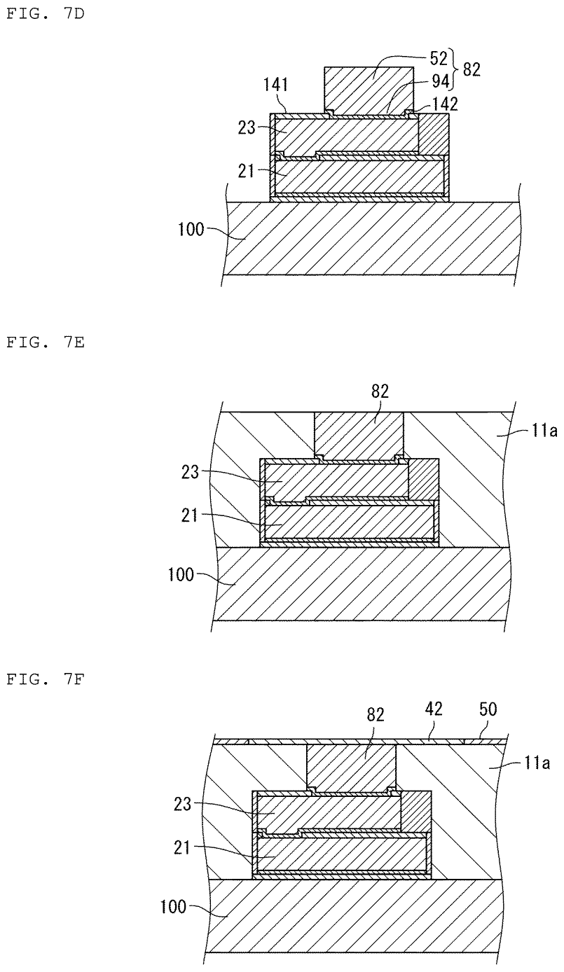

FIGS. 6A to 6M are sectional views taken along line VI-VI illustrating a manufacturing process of the inductor component 1. FIGS. 7A to 7F are sectional views taken along line VII-VII illustrating a manufacturing process of the inductor component 1. A manufacturing method of the inductor component 1 will be described with reference to FIGS. 6A to 6M and FIGS. 7A to 7F.

As illustrated in FIG. 6A, a dummy core substrate 100 is prepared. In the present embodiment, the dummy core substrate 100 is a glass epoxy substrate. Since thickness of the dummy core substrate 100 does not affect thickness of the inductor component, one containing a material and having thickness that is usually easy to handle for reasons such as warpage in processing is preferably used.

As illustrated in FIGS. 6B to 6E, a first layer including the first inductor wiring 21 is formed.

First, as illustrated in FIG. 6B, an insulating material is laminated on a first main surface 100a of the dummy core substrate 100 by a vacuum laminator, patterned by photolithography, and then cured. By this, in a YZ section, a first opening portion 101, a first insulating portion 111a, the first opening portion 101, a second insulating portion 111b, and the first opening portion 101 are sequentially formed from the right (the second side surface 14 side of the inductor component 1) toward the left side (the first side surface 13 side of the inductor component 1) as viewed in FIG. 6B. A width dimension of the first insulating portion 111a is about twice a width dimension of the second insulating portion 111b. Note that an insulating layer may be formed using a press machine without using a vacuum laminator. The first insulating portion and the second insulating portion 111b form a first insulating layer 111.

Next, as illustrated in FIG. 6C, a first seed layer 112 is formed on the first insulating layer 111. Specifically, a seed layer is spirally provided on a surface opposite to the dummy core substrate 100 of the first insulating layer 111 by a sputtering method. Resist is provided on a surface opposite to the first insulating layer 111 of the seed layer, seed etching is performed by photolithography, and then the resist is removed. By this, the first seed layer 112 is formed. Note that width of the first seed layer 112 is smaller than width of the first insulating layer 111. The first seed layer 112 is a laminate of titanium (Ti)/copper (Cu), and has titanium on the first insulating layer 111.

Furthermore, when viewed from the first main surface 100a side, the insulating portion is laminated so as to cover the first insulating layer 111 and the first seed layer 112, and patterned by photolithography. By this, as illustrated in FIG. 6D, a first insulating portion 311 is provided on the first insulating layer 111, and a second opening portion 102 is provided in a region surrounded by the first insulating portion 311.

After that, power is supplied from the first seed layer 112, and a first plating portion is deposited on the first seed layer 112 by using an electroplating method. By this, as illustrated in FIG. 6E, the first inductor wiring 21 is formed on the first seed layer 112. Note that since the seed layer is not provided in the first opening portion 101, a plating portion is not formed in the first opening portion 101.

As described above, the first layer including the first inductor wiring 21 is formed. Subsequently, as described below, as shown in FIGS. 6F and 7A and FIGS. 6G and 7B, a second layer including the second inductor wiring 22 and the third inductor wiring 23 is formed on the first layer.

First, the first layer is laminated with an insulating material, patterned by photolithography, and then cured. By this, as illustrated in FIGS. 6F and 7A, a second insulating layer 121 is provided on the first layer. Furthermore, as illustrated in FIG. 7A, a first via opening portion 151 is provided in the second insulating layer 121 to expose at least a part of the outer peripheral end 21b of the first inductor wiring 21. Although not illustrated, a second via opening portion is provided in the second insulating layer 121 to expose at least a part of the inner peripheral end 21a of the first inductor wiring 21. Note that as illustrated in FIG. 6F, the second insulating layer 121 includes a first insulating portion 121a on the right side, a second insulating portion 121b on the left side, and a third insulating portion 121c as illustrated in FIG. 7A. A width dimension of the first insulating portion 121a is about twice a width dimension of the second insulating portion 121b.

Next, as illustrated in FIGS. 6G and 7B, a second seed layer 122 is formed on a surface opposite to the first inductor wiring 21 of the second insulating layer 121 by the same method as that for the first seed layer 112. Specifically, as illustrated in FIG. 6G, a first seed portion 122a and a second seed portion 122b are provided on the first insulating portion 121a. A third seed portion 122c is provided on the second insulating portion 121b. As illustrated in FIG. 7B, a fourth seed portion 122d is provided on the third insulating portion 121c. At this time, the second seed layer 122 is also provided in the first via opening portion 151 and the second via opening portion. After the above, a second insulating portion 312 is formed by using the same method as the method of forming the first insulating portion 311. After the above, the second inductor wiring 22, specifically, the second inductor wirings 221, 222, and 223 are formed on surfaces opposite to the second insulating layer 121 of the first to third seed portions 122a to 122c by using an electroplating method similarly to the method of forming the first inductor wiring 21. Similarly, the third inductor wiring 23 is formed on a surface opposite to the second insulating layer 121 of the fourth seed portion 122d. At this time, the second via wiring 92 is formed in the first via opening portion 151, and the first via wiring 91 is formed in the second via opening portion.

As described above, the second layer including the second and third inductor wirings 22 and 23 is formed. Subsequently, as described below, as illustrated in FIGS. 6H, 7C, and 7D, a third layer is formed on the second layer.

First, an insulating material is laminated so as to cover the second layer, patterned by photolithography, and then cured. By this, as illustrated in FIG. 6H, a third insulating layer 131 is provided on a surface opposite to the second seed layer 122 of the second inductor wiring 22, and as illustrated in FIG. 7C, a fourth insulating layer 141 is provided on a surface opposite to the second seed layer 122 of the third inductor wiring 23. Furthermore, as illustrated in FIG. 7C, a fourth via opening portion 152 is provided in the fourth insulating layer 141, and the second end 23b side of the third inductor wiring 23 is exposed. Although not illustrated, a third via opening portion is provided in the fourth insulating layer 141 to expose the outer peripheral end 22b side of the second inductor wiring 22.

Next, as illustrated in FIG. 7D, a third seed layer 142 is formed in the fourth via opening portion 152 and the periphery of the fourth via opening portion 152 by using the same method as that for the first seed layer 112. After the above, the second vertical wiring 82 is formed on the third seed layer 142 by an electroplating method similarly to the method of forming the first inductor wiring 21. At this time, the second vertical wiring 82 includes the fourth via wiring 94 and the second columnar wiring 52. Although not illustrated, the third seed layer 142 is formed in the third via opening portion and the periphery of the third via opening portion by the same method as that for the first seed layer 112, and then the first vertical wiring 81 is formed on the third seed layer 142 by using the same electroplating method as the method of forming the first inductor wiring 21. Note that in the present disclosure, when the first vertical wiring 81 and the second vertical wiring 82 are formed, an insulating portion is not provided around the first vertical wiring 81 and the second vertical wiring 82, but the first vertical wiring 81 and the second vertical wiring 82 may be formed after an insulating portion is provided.

As described above, the third layer including the first vertical wiring 81 and the second vertical wiring 82 is formed.

Subsequently, as illustrated in FIGS. 5, 6I, and 7E, the resin 72 and the magnetic material 70 are added to form a magnetic layer 11a. At this time, as described below, the void portion 71 is formed in the magnetic layer 11a. Pressurization is performed when the magnetic material 70 is thermocompression-bonded. When this pressurization is started before melt viscosity of the magnetic material 70 completely decreases, flow of the magnetic material 70 decreases, so that the magnetic material 70 is supplied with air. After the above, when the magnetic material 70 is heated and the melt viscosity of the magnetic material 70 further decreases, the magnetic material 70 is sufficiently supplied, and the magnetic material 70 starts to be cured in a state where the magnetic material 70 contains the air. By this, the void portion 71 can be formed. Note that the void portion 71 may be formed by another method. For example, also by adding an additive having a small molecular weight to the inside of the magnetic material 70 and decomposing the additive at the time of curing the magnetic material 70, the void portion 71 may be formed in a portion where the additive was present. Further, the above two methods may be performed in combination, or the void portion 71 may be formed using other methods. Further, in a case where upper surfaces of the first vertical wirings 81 and the second vertical wirings 82 are not exposed, the magnetic material 70 is removed by polishing so that the upper surfaces are exposed.

As illustrated in FIGS. 6J and 7F, the coating film 50 is provided on an upper surface (second main surface). A through-hole through which end surfaces of the first vertical wiring 81 and the second vertical wiring 82 are exposed is formed in a region where an external terminal is to be formed in the coating film 50. After the above, the first external terminal 41 is provided so as to be connected to the first vertical wiring 81, and the second external terminal 42 is provided so as to be connected to the second vertical wiring 82.

After the above, the dummy core substrate 100 is removed by cutting. As illustrated in FIG. 6K, the resin 72 and the magnetic material 70 are added to a surface in contact with the dummy core substrate 100 and pressed to form the magnetic layer 11b. Note that a composition other than the resin 72 and the magnetic material 70 may be used. Note that the magnetic layer 11a and the magnetic layer 11b form the magnetic layer 11.

As illustrated in FIG. 6L, a plurality of portions to be an inductor component formed in a matrix is divided into inductor component units along a line D. By this, as illustrated in FIG. 6M, the inductor component 1 is formed.

### Second Embodiment

A configuration of the inductor component of the second embodiment is illustrated in FIGS. 1 and 2 similarly to the configuration of the inductor component 1 of the first embodiment. Note that configurations other than that described below are the same as those of the first embodiment, and will be omitted from description.

The second embodiment is different from the first embodiment in the magnetic material and the first metal magnetic powder contained in the magnetic material. This different configuration will be described below. Other configurations are the same as those of the first embodiment, are denoted by the same reference symbols as the corresponding ones of the first embodiment, and will be omitted from description.

In the second embodiment, the first metal magnetic powder contains Fe and two types selected from metals other than Fe. The first metal magnetic powder contains Fe in an amount of 80% by mass or more and 90% by mass or less (i.e., from 80% by mass to 90% by mass). Since the first metal magnetic powder is an alloy containing Fe and two kinds selected from metals other than Fe, magnetic saturation is likely to occur as compared with a case where carbonyl iron-based magnetic powder is used.

The metal other than Fe may be any general metal, and examples of the metal include chromium (Cr), copper (Cu), zirconium (Zr), aluminum (Al), titanium (Ti), and silicon (Si). In the present disclosure, Si is treated as one kind of metal for convenience according to common use.

Preferably, the two kinds other than Fe are Si and Cr. Specifically, FeSiCr can be used as the first metal magnetic powder. As the first metal magnetic powder contains Si and Cr, a crystal of the first metal magnetic powder has strain, and magnetic permeability of the magnetic layer 11 is higher than that in a case where carbonyl iron-based magnetic powder is used. In particular, as Si is contained, a crystal of the first metal magnetic powder has strain, and magnetic permeability of the magnetic layer 11 can be increased as compared with a case where only Fe is contained. Since Cr is easily oxidized, when Cr is present on a surface of the first metal magnetic powder, Cr on the surface is oxidized, and oxidization to the inside of the first metal magnetic powder can be prevented. As described above, as the first metal magnetic powder contains Si and Cr, it is possible to balance magnetic saturation with permeability of the magnetic layer 11, to increase magnetic permeability of the magnetic layer 11, and to improve the reliability of the inductor component.

Preferably, total content of Si and Cris 10% by mass or less with respect to the first metal magnetic powder, and content of Si is higher than content of Cr. A lower limit value of total content of Si and Cr is not particularly limited, but is, for example, 1% by mass or more. When content of Cr is too high, a magnetic characteristic is deteriorated. From the above, when content of Cr is low to some extent, high inductance efficiency can be realized.

### Third Embodiment

In a third embodiment, in addition to the first embodiment, the magnetic layer 11 includes an aggregate portion 75. In the third embodiment, shapes of first and second inductor wirings 21B and 22B and a shape of an insulating layer 31B are different from those of the first embodiment. Furthermore, in the third embodiment, the third inductor wiring 23 is not present. Configurations other than the above are the same as those of the first embodiment, and will be omitted from description.

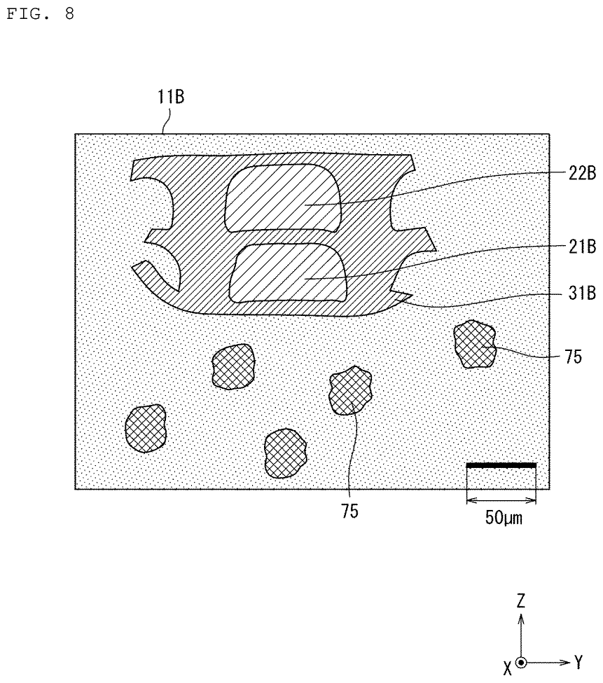

FIG. 8 is an explanatory view for explaining a part of a magnetic layer of the third embodiment. FIG. 9 is a partially enlarged view of the magnetic layer of the third embodiment.

As illustrated in FIGS. 8 and 9, in the third embodiment, a magnetic layer 11B further includes the aggregate portion 75. The aggregate portion 75 is a portion where a plurality of particles of second iron oxide magnetic powder are aggregated, an average particle diameter as the aggregate portion 75 is twice or more an average particle diameter of the first metal magnetic powder 73, and a composition of the second iron oxide magnetic powder is the same as a composition of the first iron oxide magnetic powder 74. In FIG. 9, the first metal magnetic powder 73 is carbonyl iron, and the first iron oxide magnetic powder 74 and the second iron oxide magnetic powder are magnetite. By including the aggregate portion 75, the second iron oxide magnetic powder (that is, the first iron oxide magnetic powder 74) is aggregated, and a magnetic material other than the first iron oxide magnetic powder 74, that is, the first metal magnetic powder 73 can be further added. As a result, DC bias characteristics of an inductor component 1B can be improved. Here, an average particle diameter as the aggregate portion 75 is measured using the same method as that for the first metal magnetic powder 73. Note that a composition of the second iron oxide magnetic powder may be different from a composition of the first iron oxide magnetic powder 74. Further, the first metal magnetic powder 73 may be the first metal magnetic powder in the second embodiment.

An average particle diameter as the aggregate portion 75 is not particularly limited, but may be, for example, smaller than 50 times, or 40 times or less, the average particle diameter of the first metal magnetic powder 73. When an average particle diameter of the aggregate portion 75 becomes too large, the first iron oxide magnetic powder 74 does not exist between particles of the first metal magnetic powder 73, and as a result, insulation property between particles of the first metal magnetic powder 73 decreases, and the loss tan δ of the magnetic material increases.

Preferably, the number of the aggregate portions 75 is 0.1 or less per 1 μm² of the magnetic layer. A lower limit value of the aggregate portion 75 is not particularly limited, but for example, 10⁻⁵ or more aggregate portions may be present per 1 μm² of the magnetic layer. When the number of the aggregate portions 75 is large, insulation property between particles of the first metal magnetic powder 73 is lowered, and the loss tan δ of the magnetic material is increased.

Preferably, the aggregate portion 75 is not formed in the inner magnetic circuit portion 24. That is, the aggregate portion 75 is formed in at least one of the outer magnetic circuit portion 25, the first magnetic portion 26a, the third magnetic portion 26c, the fifth magnetic portion 26e, and the sixth magnetic portion 26f. More preferably, the aggregate portion 75 is formed in at least one of the first magnetic portion 26a, the third magnetic portion 26c, and the fourth magnetic portion 26d. With the above configuration, inductance acquisition efficiency is increased.

### (Manufacturing Method)

A manufacturing method of the inductor component 1B will be described.

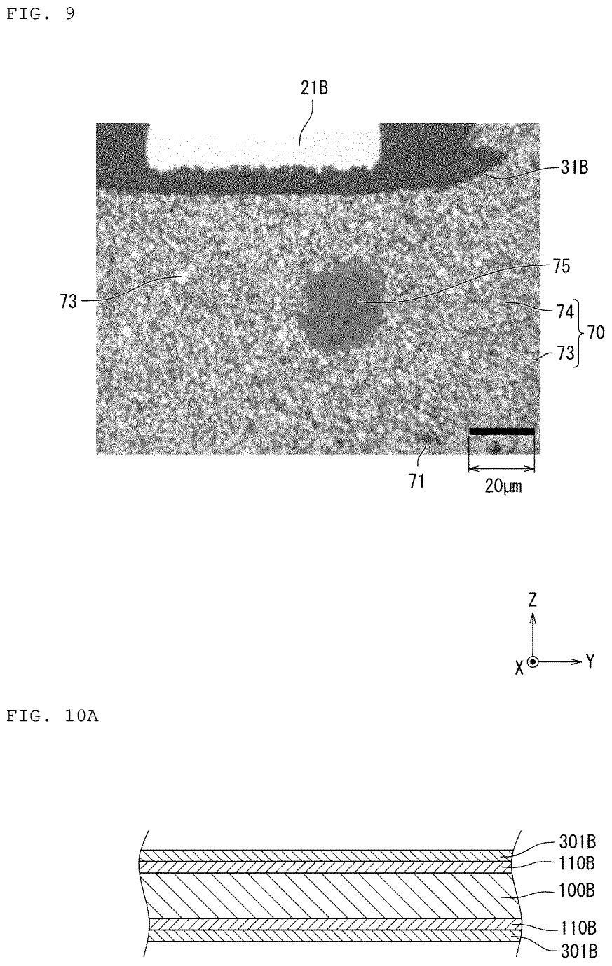

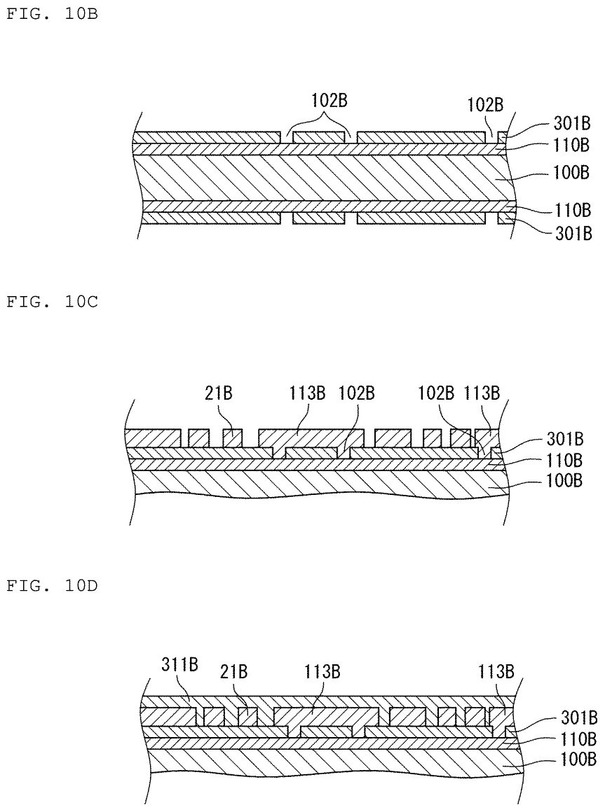

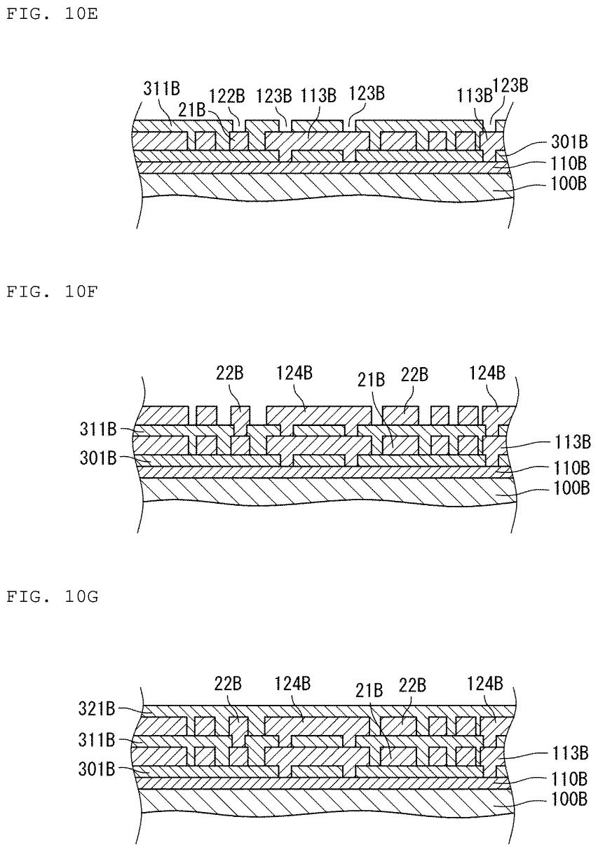

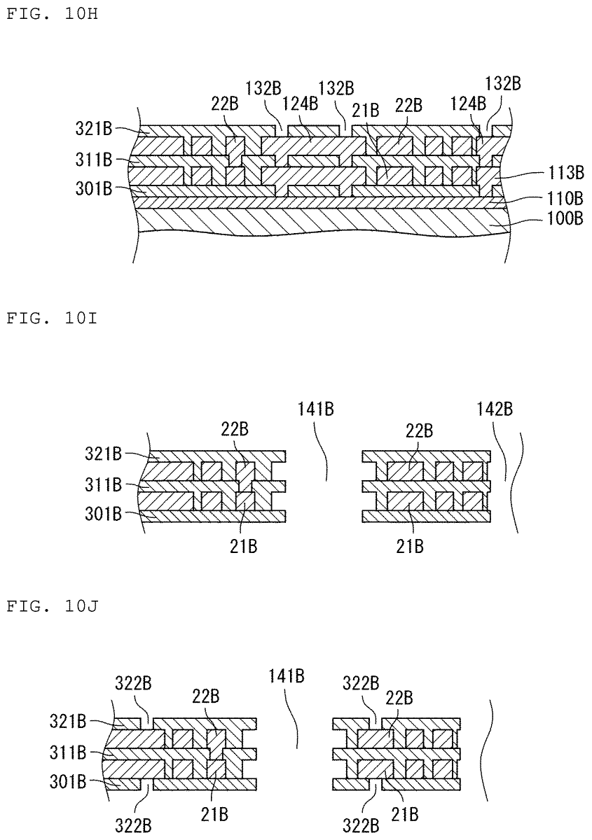

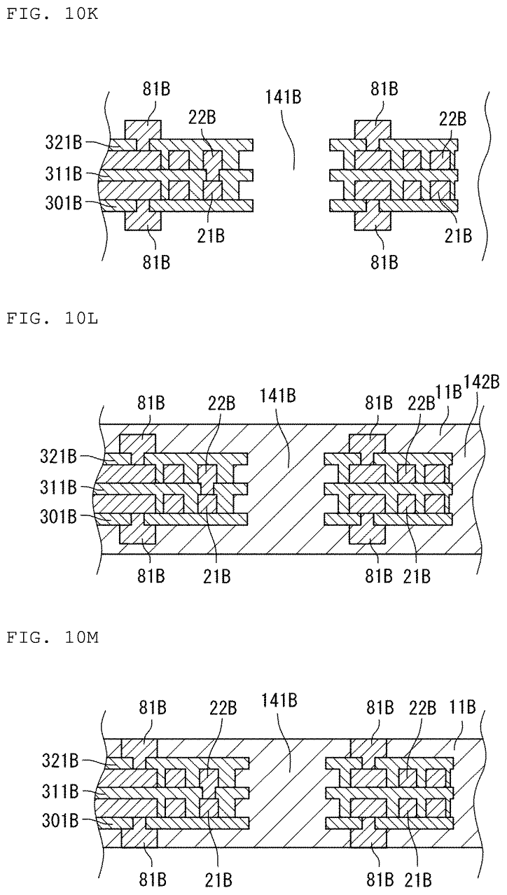

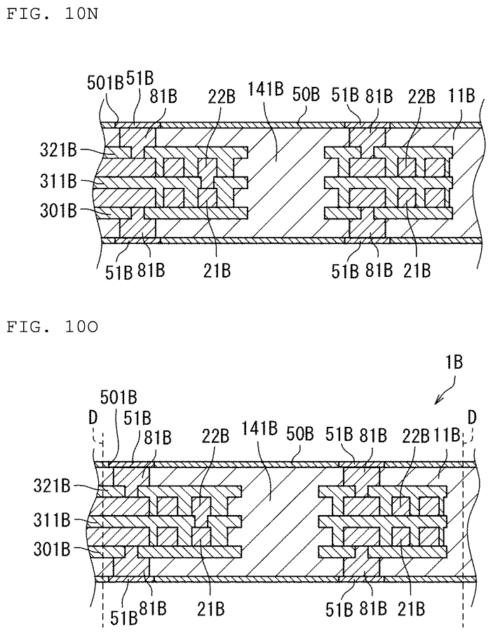

As illustrated in FIG. 10A, a dummy core substrate 100B is prepared. The dummy core substrate 100B has substrate copper foil on both surfaces. In the present embodiment, the dummy core substrate 100B is a glass epoxy substrate. Since thickness of the dummy core substrate 100B does not affect thickness of an inductor array component, one containing a material and having thickness that is easy to handle as appropriate for reasons such as warpage in processing is preferably used.

Next, copper foil 110B is adhered to a surface of substrate copper foil. The copper foil 110B is adhered to a smooth surface of the substrate copper foil. For this reason, adhesive strength between the copper foil 110B and the substrate copper foil can be weakened, so that the dummy core substrate 100B can be easily peeled from the copper foil 110B in a later step. Preferably, an adhesive for adhering the dummy core substrate 100B and a dummy metal layer (the copper foil 110B) is a low-adhesion adhesive. Further, in order to weaken adhesive strength between the dummy core substrate 100 and the copper foil 110B, an adhesive surface between the dummy core substrate 100B and the copper foil 110B is desirably a glossy surface.

After the above, an insulating layer 301B is laminated on the copper foil 110B. At this time, the insulating layer 301B is thermocompression-bonded and thermally cured by a vacuum laminator, a press machine, or the like.

As illustrated in FIG. 10B, an opening portion 102B is formed in the insulating layer 301B by laser processing or the like. Then, as illustrated in FIG. 10C, dummy copper 113B and the inductor wiring 21B are formed on the insulating layer 301B. Specifically, a power supply film (not illustrated) for SAP is formed on the insulating layer 301B by electroless plating, sputtering, vapor deposition, or the like. After the power supply film is formed, photosensitive resist is applied or bonded on the power supply film, and an opening portion of the photosensitive resist is formed by photolithography in a portion to be a wiring pattern. After the above, a metal wiring corresponding to the dummy copper 113B and the inductor wiring 21B is formed in the opening portion of the photosensitive resist layer. After the metal wiring is formed, the photosensitive resist is peeled off with a chemical solution and the power supply film is removed by etching. After the above, additional copper electroplating is performed with this metal wiring serving as a power supply portion, so that a wiring in a small space can be obtained. Further, the opening portion 102B formed in FIG. 10B is filled with copper by SAP.

Then, as illustrated in FIG. 10D, the dummy copper 113B and the inductor wiring 21B are covered with an insulating layer 311B. The insulating layer 311B is thermocompression-bonded and thermally cured by a vacuum laminator, a press machine, or the like.

Next, as illustrated in FIG. 10E, an opening portion 122B and an opening portion 123B are formed in the insulating layer 311B by laser processing or the like. As illustrated in FIG. 10F, dummy copper 124B and the inductor wiring 22B are formed on the insulating layer 311B in the same method as that for the dummy copper 113B and the inductor wiring 21B. Then, as illustrated in FIG. 10G, the dummy copper 124B and the inductor wiring 22B are covered with an insulating layer 321B. Next, as illustrated in FIG. 10H, an opening portion 132B is formed in the insulating layer 321B by laser processing or the like.

After the above, the dummy core substrate 100B is peeled off from the copper foil 110B. Then, the copper foil 110B is removed by etching or the like, and the dummy copper 113B and the dummy copper 124B are removed by etching or the like to form a hole portion 141B corresponding to an inner magnetic circuit and a hole portion 142B corresponding to an outer magnetic circuit as illustrated in FIG. 10I.

After the above, as illustrated in FIG. 10J, an insulating layer opening portion 322B is formed by laser processing or the like. Then, as illustrated in FIG. 10K, the insulating layer opening portion 322B is filled with copper by SAP, and a vertical wiring 81B is formed on the insulating layer 301B and the insulating layer 321B. Note that the insulating layers 301B, 311B, and 321B form the insulating layer 31B.

Next, as illustrated in FIG. 10L, an inductor wiring, an insulating layer, and a vertical wiring are covered with the magnetic layer 11B to form an inductor substrate. The magnetic layer 11B is thermocompression-bonded and thermally cured by a vacuum laminator, a press machine, or the like. At this time, the hole portions 141B and 142B are also filled with the magnetic layer 11B.

Then, as illustrated in FIG. 10M, the upper and lower magnetic layers 11B of the inductor substrate are thinned by a grinding method. At this time, an exposed portion of the vertical wiring 81B is formed on the same plane of the magnetic layer 11B by exposing a part of the vertical wiring 81B. At this time, by grinding the magnetic layer 11B to a thickness sufficient to obtain a desired inductance value, the inductor component can be thinned.

After the above, as illustrated in FIG. 10N, insulating resin (coating film) 50B is formed on a surface of the magnetic body by a printing method. Here, an opening portion 501B in the insulating resin 50B is a portion where an external terminal is formed. In the present embodiment, a printing method is used, but the opening portion 501B may be formed by a photolithography method. Then, electroless copper plating or a plated film of Ni, Au, or the like is applied to the opening portion 501B to form an external terminal 51B. Subsequently, as illustrated in FIG. 10O, the inductor component 1B is obtained by singulation by dicing along the line D. Although not illustrated in FIGS. 10C to 10H, the inductor substrates are formed on both surfaces of the dummy core substrate 100B. By this, high productivity can be obtained. Note that the inductor substrate can be formed on either both surfaces or one surface.

Note that the present disclosure is not limited to the above-described embodiments, and can be changed in design without departing from the gist of the present disclosure. For example, characteristic features of the first to third embodiments may be combined in various ways. Further, the number of inductor wiring layers may be increased or decreased, and the number of via wiring layers may be increased or decreased. The manufacturing method of the inductor component is not particularly limited, and for example, the third embodiment may be manufactured by the manufacturing method of the first embodiment, and the first embodiment and the second embodiment may be manufactured by the manufacturing method of the third embodiment.

The present disclosure includes an aspect below.

<1> A coil component including an element body including a magnetic layer; and a first coil wiring disposed in the element body. The magnetic layer includes resin, first metal magnetic powder, first iron oxide magnetic powder, and a void portion, and an average particle diameter of the first metal magnetic powder is larger than an average particle diameter of the first iron oxide magnetic powder.

<2> The coil component according to <1>, in which at least one particle of the first metal magnetic powder and at least one particle of the first iron oxide magnetic powder are in contact with each other.

<3> The coil component according to <2>, in which the at least one particle of the first metal magnetic powder is in contact with at least one particle of the first iron oxide magnetic powder and at least one of the void portions.

<4> The coil component according to <2> or <3>, further including a first vertical wiring extending from a first end side of the first coil wiring so as to expose inside of the element body to a first main surface of the element body. The at least one particle of the first metal magnetic powder is in contact with at least one of the first vertical wiring and the first coil wiring, at least one of the void portions, and at least one particle of the first iron oxide magnetic powder.

<5> The coil component according to <4>, in which the at least one particle of the first metal magnetic powder is in contact with the first vertical wiring, at least one of the void portions, and at least one particle of the first iron oxide magnetic powder.

<6> The coil component according to any one of <1> to <5>, in which the first metal magnetic powder contains Fe in an amount of 95% by mass or more.

<7> The coil component according to any one of <1> to <6>, in which the first metal magnetic powder contains Cu in an amount of 1% by mass or more and 5% by mass or less (i.e., from 1% by mass to 5% by mass).

<8> The coil component according to any one of <1> to <5>, in which the first metal magnetic powder contains Fe and two kinds selected from metals other than Fe, and the Fe is contained in an amount of 80% by mass or more and 90% by mass or less (i.e., from 80% by mass to 90% by mass) with respect to the first metal magnetic powder.

<9> The coil component according to <8>, in which the two kinds are Si and Cr.

<10> The coil component according to any one of <8> and <9>, in which total content of the two kinds is 10% by mass or less with respect to the first metal magnetic powder, and content of the Si is higher than content of the Cr.

<11> The coil component according to any one of <1> to <10>, in which an average particle diameter of the first metal magnetic powder is 0.5 μm or more and 2.5 μm or less (i.e., from 0.5 μm to 2.5 μm). Also, an average particle diameter of the first iron oxide magnetic powder is 0.01 μm or more and 0.5 μm or less (i.e., from 0.01 μm to 0.5 μm), and an average particle diameter of the first metal magnetic powder is 5 times or more an average particle diameter of the first iron oxide magnetic powder.

<12> The coil component according to any one of <1> to <11>, in which in the magnetic layer, a filling rate of the first metal magnetic powder is higher than a filling rate of the first iron oxide magnetic powder.

<13> The coil component according to any one of <1> to <12>, in which the first metal magnetic powder includes an insulating coating portion, and at least one of the insulating coating portions and at least one particle of the first iron oxide magnetic powder are in contact with each other.

<14> The coil component according to any one of <1> to <13>, in which the first iron oxide magnetic powder contains Fe and O, the Fe is contained in an amount of 60% by mass or more and 85% by mass or less (i.e., from 60% by mass to 85% by mass), content of the O is high following content of the Fe, and electrical conductivity of the first metal magnetic powder is 10 times or more higher than electrical conductivity of the first iron oxide magnetic powder.

<15> The coil component according to any one of <1> to <14>, in which a linear expansion coefficient of the first metal magnetic powder is larger than a linear expansion coefficient of the first iron oxide magnetic powder.

<16> The coil component according to any one of <1> to <15>, in which the magnetic layer further includes an aggregate portion, and the aggregate portion is a portion where second iron oxide magnetic powder is aggregated. Also, an average particle diameter as the aggregate portion is twice or more the average particle diameter of the first metal magnetic powder, and a composition of the second iron oxide magnetic powder is the same as a composition of the first iron oxide magnetic powder.

<17> The coil component according to any one of <1> to <16>, in which circularity of the first metal magnetic powder and the first iron oxide magnetic powder is higher than 0.9.

<18> The coil component according to any one of <1> to <17>, in which the magnetic layer further contains second metal magnetic powder.

<19> The coil component according to <18>, in which the first metal magnetic powder is carbonyl iron-based magnetic powder, the second metal magnetic powder is amorphous alloy-based magnetic powder, and an average particle diameter of the second metal magnetic powder is larger than an average particle diameter of the first metal magnetic powder.

<20> A surface mount electronic component including the coil component according to any one of <1> to <19>.

<21> A semiconductor component including the coil component according to any one of <1> to <19>.

<22> A substrate comprising the coil component according to any one of <1> to <19>.

What is claimed is:

1. A coil component comprising:
an element body including a magnetic layer; and
a first coil wiring in the element body, wherein
the magnetic layer includes resin, first metal magnetic powder, first iron oxide magnetic powder, and at least one void portion, and
an average particle diameter of the first metal magnetic powder is larger than an average particle diameter of the first iron oxide magnetic powder.

2. The coil component according to claim 1, wherein
at least one particle of the first metal magnetic powder and at least one particle of the first iron oxide magnetic powder are in contact with each other.

3. The coil component according to claim 2, wherein
the at least one particle of the first metal magnetic powder is in contact with at least one particle of the first iron oxide magnetic powder and the at least one void portion.

4. The coil component according to claim 2, further comprising:
a first vertical wiring extending from a first end side of the first coil wiring through inside of the element body and exposed on a first main surface of the element body, wherein
the at least one particle of the first metal magnetic powder is in contact with at least one of the first vertical wiring and the first coil wiring, the at least one void portion, and at least one particle of the first iron oxide magnetic powder.

5. The coil component according to claim 4, wherein
the at least one particle of the first metal magnetic powder is in contact with the first vertical wiring, the at least one void portion, and at least one particle of the first iron oxide magnetic powder.

6. The coil component according to claim 1, wherein
the first metal magnetic powder includes Fe in an amount of 95% by mass or more.

7. The coil component according to claim 1, wherein
the first metal magnetic powder includes Cu in an amount of from 1% by mass to 5% by mass.

8. The coil component according to claim 1, wherein
the first metal magnetic powder includes Fe and two kinds selected from metals other than Fe, and
the Fe is included in an amount of from 80% by mass to 90% by mass with respect to the first metal magnetic powder.

9. The coil component according to claim 8, wherein
the two kinds are Si and Cr.

10. The coil component according to claim 9, wherein
total content of the two kinds is 10% by mass or less with respect to the first metal magnetic powder, and
content of the Si is higher than content of the Cr.

11. The coil component according to claim 1, wherein
an average particle diameter of the first metal magnetic powder is from 0.5 μm to 2.5 μm,
an average particle diameter of the first iron oxide magnetic powder is from 0.01 μm to 0.5 μm, and
an average particle diameter of the first metal magnetic powder is 5 times or more an average particle diameter of the first iron oxide magnetic powder.

12. The coil component according to claim 1, wherein
in the magnetic layer, a filling rate of the first metal magnetic powder is higher than a filling rate of the first iron oxide magnetic powder.

13. The coil component according to claim 1, wherein
the first metal magnetic powder includes at least one insulating coating portion, and
the at least one insulating coating portion and at least one particle of the first iron oxide magnetic powder are in contact with each other.

14. The coil component according to claim 1, wherein
the first iron oxide magnetic powder includes Fe and O,
the Fe is included in an amount of from 60% by mass to 85% by mass,
content of the O is high following content of the Fe, and
electrical conductivity of the first metal magnetic powder is 10 times or more higher than electrical conductivity of the first iron oxide magnetic powder.

15. The coil component according to claim 1, wherein
a linear expansion coefficient of the first metal magnetic powder is larger than a linear expansion coefficient of the first iron oxide magnetic powder.

16. The coil component according to claim 1, wherein
the magnetic layer further includes an aggregate portion,
the aggregate portion is a portion where second iron oxide magnetic powder is aggregated,
an average particle diameter as the aggregate portion is twice or more the average particle diameter of the first metal magnetic powder, and
a composition of the second iron oxide magnetic powder is same as a composition of the first iron oxide magnetic powder.

17. The coil component according to claim 1, wherein
circularity of the first metal magnetic powder and the first iron oxide magnetic powder is higher than 0.9.

18. The coil component according to claim 1, wherein
the magnetic layer further includes second metal magnetic powder.

19. The coil component according to claim 18, wherein
the first metal magnetic powder is carbonyl iron-based magnetic powder,
the second metal magnetic powder is amorphous alloy-based magnetic powder, and
an average particle diameter of the second metal magnetic powder is larger than an average particle diameter of the first metal magnetic powder.

20. A surface mount electronic component comprising the coil component according to claim 1.

21. A semiconductor component comprising the coil component according to claim 1.

22. A substrate comprising the coil component according to claim 1.
